(19) United States
(12) Patent Application Publication
(10) Pub. No.: US 2026/0225036 A1
(43) Pub. Date: Aug. 6, 2026

(54) CARBON CAPTURE SYSTEMS AND METHODS OF USE THEREOF

(71) Applicant: Lehigh University, Bethlehem, PA (US)

(72) Inventor: Kai LANDSKRON, Bethlehem, PA (US)

(73) Assignee: Lehigh University, Bethlehem, PA (US)

(21) Appl. No.: 19/149,457

(22) PCT Filed: Jan. 22, 2024
(86) PCT No.: PCT/US2024/012333

§ 371 Date: Jul. 18, 2025

Related U.S. Application Data
(60) Provisional application No. 63/440,283, filed on Jan. 20, 2023.

(51) Int. Cl. B01D 53/32

(52) U.S. Cl. CPC B01D 53/326; B01D 2257/504; B01D 2259/818

(57) ABSTRACT

Carbon capture systems, apparatuses, and methods thereof are disclosed herein. According to an aspect, provided is a capacitive carbon capture system comprising: carbon capture module(s) comprising: a first current collector; a second current collector and spaced from the first current collector; a first carbon capture cell and a second carbon capture cell, the first carbon capture cell and the second carbon capture cell each comprising: a first electrode comprising a first surface and a second surface opposed the first surface, a second electrode spaced from the first electrode, the second electrode comprising a first surface and a second surface opposed the first surface, an electrolyte solution in contact with the second surface of the first electrode and the first surface of the second electrode, and a gas permeable layer comprising a first surface and a second surface opposed to the first surface; and a barrier extending between.

### CROSS-REFERENCE TO RELATED APPLICATIONS

This application claims the benefit of priority from U.S. Provisional Application No. 63/440,283, filed Jan. 20, 2023, the contents of which are hereby incorporated herein by reference in their entirety.

### BACKGROUND OF THE INVENTION

Industrial-scale gas separation can be performed using various techniques that allow for the enrichment or actual separation of a gas of interest. Swing adsorption techniques are based on processes in which controlled cycling of an experimental parameter allows for differential adsorption and release of a gas in a medium. Pressure swing adsorption (PSA) pressurizes and depressurizes gas around an adsorbent media to selectively adsorb certain components of a gas, allowing others to be selectively discarded. Vacuum swing adsorption (VSA) uses the same general principle as PSA, but swings between vacuum pressures and atmospheric pressure. The two techniques may be combined, and are called “vacuum pressure swing adsorption” (VPSA) in this case. Further, temperature swing adsorption (TSA) uses a similar technique to other swing adsorption techniques but cycles temperature instead of pressure. Cryogenic distillation is typically only used for very high volumes because of its nonlinear cost-scale relationship, which makes the process more economical at larger scales. Membrane technologies are not as well-developed as other gas separation techniques and as a result they are less widely used. Partially permeable membranes allow “fast” gases to pass through and be removed, while “slow” gases remain in the airstream and emerge without the original contaminants. However, manufacturing challenges mean the units are better suited for small to mid-scale operations.

PSA and TSA are often used in industrial settings, but have significant disadvantages, especially high energy consumption. This often prevents cost-effective large-scale gas separations, such as Gigaton-level carbon dioxide capture from the flue gas of coal-fired power plants. In fact, separating CO₂ from flue gas with known established PSA or TSA techniques would consume >30% of the power of a power plant. That large energy consumption would increase (about double) the price of electricity. In addition, direct capture of CO₂ from air will likely be required in the future to control climate change, and has even larger demands on energy consumption, mass flow, and pressure drop. Electrical and electrochemical approaches have been considered as alternative techniques to the classical PSA and TSA technologies. However, the techniques known in the art suffer from similar problems as TSA and PSA, namely, that there is a permanent electrical current flow which consumes a large amount of energy.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description and brief description of the drawings provided below.

Aspects of the disclosure are generally directed to carbon capture systems, carbon capture modules, and methods for capturing carbon dioxide from a gas, such as air. The carbon capture systems and carbon capture modules disclosed herein may preferably be configured to be capacitive carbon systems and/or capacitive carbon apparatuses. Desirably, the capacitive carbon capture system disclosed herein may be scaled with minimum or without a negative impact on adsorptive performance while having a positive impact on energy consumption, and space consumption. It was surprisingly discovered that the carbon capture systems disclosed herein may be configured to be extremely selective for CO₂, and even remove trace amounts of CO₂ from gas mixtures, such as from air. Additionally, the inventors unexpectedly determined that certain carbon capture modules disclosed herein having certain components and arrangements thereof may be configured with a reduced number of current collectors, which is a significant cost benefit. Further, it was unexpectedly determined that in certain embodiments, increasing the number of bipolar electrodes in the carbon capture module led to a decreasing amount of energy consumption. The carbon capture modules and/or systems may be configured to avoid evaporation of the electrolyte composition therein. For example, the inventors discovered that certain carbon capture modules and/or systems having certain components and arrangements in combination with electrolyte compositions having select electrolytes may exhibit minimal to no evaporation of the electrolyte compositions or electrolyte solutions.

The carbon capture modules and/or systems disclosed herein may be configured for energy storage. For instance, the carbon capture modules and/or systems disclosed herein may be configured for both carbon dioxide capture from air and for energy storage. The carbon capture modules and/or systems disclosed herein may advantageously be used in combination with intermittent renewable energy produces, such that carbon capture modules and/or systems operate primarily for carbon capture when electricity prices are low and provide electricity to the grid when electricity prices are high.

In accordance with an aspect of the invention, provided is a capacitive carbon capture system comprising: one or more carbon capture modules comprising: a first current collector having a surface; a second current collector having a surface and spaced from the first current collector; a first carbon capture cell and a second carbon capture cell, the first carbon capture cell and the second carbon capture cell each comprising: a first electrode comprising a first surface and a second surface opposed the first surface, a second electrode spaced from the first electrode, the second electrode comprising a first surface and a second surface opposed the first surface, an electrolyte solution in contact with the second surface of the first electrode and the first surface of the second electrode, and a gas permeable layer comprising a first surface and a second surface opposed to the first surface; and a barrier extending between the first carbon capture cell and the second carbon capture cell, the barrier being electrically conductive, and impermeable for ions. The electrolyte solution may be disposed in a separator, wherein the separator is a porous, electronically non-conducting material.

The first carbon capture cell and the second carbon capture cell may be positioned at least partially in the space between the first current collector and the second current collector. The barrier may extend adjacent to the second surface of the second electrode of the first carbon capture cell and adjacent to the first surface of the gas permeable layer of the second carbon capture cell. In certain embodiments, the second surface of the gas permeable layer extends adjacent to the first surface of the first electrode.

According to some exemplary embodiments, the first surface of the gas permeable layer of the first carbon capture cell extends adjacent to the surface of the first current collector and the second surface of the second electrode of the second carbon capture cell extends adjacent to the surface of the second current collector. In at least one instance, the barrier has a first surface and a second surface, wherein the barrier is configured to prevent movement of ions from the first carbon capture cell to the second carbon capture cell.

According to another aspect of the invention, provided is capacitive carbon capture system comprising: one or more carbon capture modules comprising: a first current collector having a surface; a second current collector having a surface and spaced from the first current collector; a first carbon capture cell and a second carbon capture cell, wherein the first carbon capture cell and the second carbon capture cell are positioned at least partially in the space between the first current collector and the second current collector, the first carbon capture cell and the second carbon capture cell each comprising: a first electrode comprising a first surface and a second surface opposed the first surface, a second electrode spaced from the first electrode, the second electrode comprising a first surface and a second surface opposed the first surface, an electrolyte solution in contact with the second surface of the first electrode and the first surface of the second electrode, and a gas permeable layer comprising a first surface and a second surface opposed to the first surface, the second surface of the gas permeable layer extending adjacent to the first surface of the first electrode; and a barrier extending between the first carbon capture cell and the second carbon capture cell, the barrier being electrically conductive and non-permeable for ions, wherein the barrier extends adjacent the second surface of the second electrode of the first carbon capture cell and adjacent the first surface of the gas permeable layer of the second carbon capture cell, wherein the first surface of the gas permeable layer of the first carbon capture cell extends adjacent to the surface of the first current collector and the second surface of the second electrode of the second carbon capture cell extends adjacent to the surface of the second current collector.

The carbon capture module may further comprise a feed inlet conduit extending transversally through the first and the second surface of the gas permeable layer of the first carbon capture cell and extending transversally through the first and the second surface of the gas permeable layer of the second carbon capture cell. In some cases, the feed inlet conduit extends perpendicularly through the first and the second surface of the gas permeable layer of the first carbon capture cell and extends perpendicularly through the first and the second surface of the gas permeable layer of the second carbon capture cell.

The carbon capture module may further comprise a feed outlet conduit extending transversally through the first and the second surface of the gas permeable layer of the first carbon capture cell and extending transversally through the first and the second surface of the gas permeable layer of the second carbon capture cell. In at least one embodiment, the feed outlet conduit extends perpendicularly through the first and the second surface of the gas permeable layer of the first carbon capture cell and extends perpendicularly through the first and the second surface of the gas permeable layer of the second carbon capture cell.

The carbon capture system may further comprise a feed stream received by the gas inlet conduit, the feed stream comprising carbon dioxide (“CO₂”). The CO₂ may be present in the feed stream in an amount of about 300 ppm or more (e.g., about 300 ppm to about 18 vol. % relative to the total volume of the feed stream). For instance, CO₂ may be present in the feed stream in an amount of about 300 ppm to about 500 ppm, optionally about 400 ppm.

In accordance with a further aspect of the invention, provided is a capacitive carbon capture system comprising: one or more carbon capture modules comprising: a gas inlet conduit; a first current collector having a surface; a second current collector having a surface and spaced from the first current collector; a first carbon capture cell and a second carbon capture cell, the first carbon capture cell and the second carbon capture cell each comprising: a first electrode comprising a first surface and a second surface opposed the first surface, a second electrode spaced from the first electrode, the second electrode comprising a first surface and a second surface opposed the first surface, an electrolyte solution in contact with the second surface of the first electrode and the first surface of the second electrode, and a gas permeable layer comprising a first surface and a second surface opposed to the first surface; and a barrier extending between the first carbon capture cell and the second carbon capture cell, the barrier being electrically conductive and non-permeable for ions; and a feed stream received by the gas inlet conduit, the feed stream comprising about 400 ppm of CO₂.

In some embodiments, one or both of the first electrode and the second electrode comprise a porous capacitive and/or pseudocapacitive material. In a non-limiting example, one or both of the first electrode and the second electrode comprise a material selected from activated carbons, oxides, sulfides, nitrides, carbides, or a combination of two or more thereof. For example, one or both of the first electrode and the second electrode may comprise biomass-derived carbon.

Preferably, one or both of the first electrode and the second electrode comprise garlic root-derived carbon. In some embodiments, one or both of the first electrode and the second electrode comprises air-oxidized garlic-root carbon. Preferably, the one or both of the first electrode and the second electrode have not been hot pressed.

The electrolyte solution comprises a salt that may be deliquescent. In certain embodiments, the electrolyte solution comprises MgBr₂, MgCl₂, CsF, CaCl₂, KF, CaBr₂, LiCl, LiBr, or a combination thereof. For instance, the electrolyte solution may comprise MgBr₂, MgCl₂, CsF, or a combination thereof. The deliquescence avoids the evaporation of the electrolyte over a wide range of relative humidity and temperature of the feed gas.

In certain embodiments, at least one carbon capture module is configured such that the first and second carbon capture cells are in electrical connection with only one current collector. The one or more carbon capture modules may be free of a third current collector, optionally, wherein each of the capture modules is free of a third current conductor. In some embodiments, the one or more carbon capture modules consists of two current collectors, optionally, wherein each of the capture modules consists of two current conductors.

The capacitive carbon capture system may further comprise a valve configured to permit the feed stream from flowing to the first carbon capture module while preventing the feed stream from flowing to the second carbon capture module or to prevent the feed stream from flowing to the first carbon capture module while permitting the feed stream from flowing to the second carbon capture module.

The first carbon capture module and the second carbon capture module are configured to be capacitively charged by applying a voltage to the respective carbon capture module. For example, the first carbon capture module and the second carbon capture module may be configured to be alternately capacitively charged. In some embodiments, capacitively charging the first carbon capture module and/or the second carbon capture module comprises absorbing CO₂ from the feed stream into the electrolyte solution inside the pores of the electrode adjacent to the gas-permeable layer, wherein the CO₂ absorbed in the electrolyte solution hydrolyzes to form a cation and an anion.

Capacitively charging the first carbon capture module and/or the second carbon capture module may further comprise the cation or the anion being adsorbed to the first electrode. Capacitively charging the first carbon capture module and/or the second carbon capture module may further comprise the cation or the anion being adsorbed to the second electrode. In some embodiments, when voltage is applied to the first electrode and the second electrode of the respective carbon capture module, the cation is adsorbed to one of the first electrode or the second electrode and the anion is adsorbed to the other of the first electrode or the second electrode.

The first carbon capture module and the second carbon capture module may be configured to be capacitively discharged. Capacitively discharging one of the first carbon capture module or the second carbon capture module may release gaseous CO₂. Capacitively discharging the first carbon capture module and/or the second carbon capture module may comprise releasing the adsorbed cation and/or anion from the respective electrode.

In certain embodiments, the electricity associated with discharging the first carbon capture module or the second carbon capture module is used for charging the other of the first carbon capture module or the second carbon capture module. The electricity associated with discharging the first carbon capture module or the second carbon capture module may be delivered to the electrical grid. In at least one embodiment, the capacitive carbon capture system has a first surface and an opposed second surface, and at least one of the first surface and the second surface are a structurally supporting component in a wall, a fence, a support for a solar panel, or a wind turbine. The capacitive carbon capture system may be configured to be positioned within a wall or a fence.

Preferably, the one or more carbon capture modules comprises a bipolar electrode. In some embodiments, the one or more carbon capture modules is configured such that the second electrode of the first carbon capture cell, the first electrode of the second carbon capture cell, and the barrier extending there between form the bipolar electrode. In certain preferred embodiments, the one or more carbon capture modules comprise a number of bipolar electrodes that is one less than the number of carbon capture cells in the respective carbon capture module.

In accordance with an yet another aspect of the invention, provided is a capacitive carbon capture system comprising: one or more carbon capture modules comprising: a first current collector having a surface; a second current collector having a surface and spaced from the first current collector; a first carbon capture cell and a second carbon capture cell, the first carbon capture cell and the second carbon capture cell each comprising: a first electrode comprising a first surface and a second surface opposed the first surface, a second electrode spaced from the first electrode, the second electrode comprising a first surface and a second surface opposed the first surface, an electrolyte solution in contact with the second surface of the first electrode and the first surface of the second electrode; and a barrier extending between the first carbon capture cell and the second carbon capture cell, the barrier being electrically conductive, and impermeable for ions.

In accordance with an aspect of the invention, provided is a cyclic process using the capacitive carbon capture system disclosed herein, the process comprising: providing the feed stream to the first carbon capture module; capacitively charging the first carbon capture module; prohibiting flow of the feed stream to the first carbon capture module; optionally, evacuating the first carbon capture module to reach a pressure of about 0.1 to about 0.3 atmospheres; capacitively discharging the first carbon capture module; releasing gaseous CO₂ from the first carbon capture module, providing the feed stream to the second carbon capture module; prohibiting flow of feed stream to the first carbon capture module; capacitively charging the second carbon capture module; optionally, evacuating the second carbon capture module to reach a pressure of 0.1 to about 0.3 atmospheres; capacitively discharging the second carbon capture module; releasing gaseous CO₂ from the first carbon capture module.

### BRIEF DESCRIPTION OF THE DRAWINGS

The following detailed description of various embodiments of the invention will be better understood when read in conjunction with the appended drawings. For the purpose of illustrating the invention, certain embodiments are shown in the drawings. It should be understood, however, that the invention is not limited to the precise arrangements and instrumentalities of the embodiments shown in the drawings.

FIG. 1 is a schematic of a non-limiting, example of a capacitive carbon capture system according to an aspect of the invention;

FIG. 2A is a schematic of the non-limiting, example of a carbon capture module in accordance with an aspect of the invention;

FIG. 2B is a schematic of another non-limiting, example of a carbon capture module according to an aspect of the invention;

FIG. 3A is a schematic of a non-limiting, example of a laboratory setup representing a simplified capacitive carbon capture system in accordance with an aspect of the invention;

FIG. 3B is a schematic of the non-limiting, example of a laboratory setup representing a simplified carbon capture module depicted in FIG. 3A;

FIG. 4 is a table of the energetic and adsorptive performance from experiments with different electrodes for the carbon capture module depicted in FIGS. 3A and 3B;

FIG. 5A is a graph showing the change in carbon dioxide concentration as function of voltage for electrode made from garlic root-derived carbon that has not been post-treated with air according to an aspect of the invention;

FIG. 5B is a graph showing the change in carbon dioxide concentration as function of voltage for electrodes made from garlic root derived carbon that has been post-treated with air in accordance with an aspect of the invention;

FIG. 5C is a graph showing the change in carbon dioxide concentration as function of voltage for hot-pressed, garlic root-derived carbon that has been post-treated by air according to an aspect of the invention;

FIG. 5D is a graph showing the change in carbon dioxide concentration as function of voltage for commercially available electrodes (Materials Method) in accordance with an aspect of the invention;

FIG. 6A is a graph of the cyclic voltammograms for an exemplary carbon capture module having two carbon capture cells according to aspects of the invention;

FIG. 6B is a graph of the cyclic voltammograms for an exemplary carbon capture module having four carbon capture cells in accordance with to aspects of the invention;

FIG. 6C is a graph of the cyclic voltammograms for an exemplary carbon capture module having eight carbon capture cells according to aspects of the invention;

FIG. 6D is a graph of the cyclic voltammograms for an exemplary carbon capture module having twelve carbon capture cells in accordance with to aspects of the invention;

FIG. 6E is a schematic of how to check the voltage distribution across the pairs of electrodes in an exemplary carbon capture module according to aspects of the invention;

FIG. 6F is a graph showing voltage distribution in an exemplary carbon capture module having 2 carbon capture cells, 4 carbon capture cells, 8 carbon capture cells, or 12 carbon capture cells in accordance with aspects of the invention;

FIG. 6G is a graph showing the impedence spectra of four non-limiting, exemplary capacitive carbon capture modules having either 2 carbon capture cells, 4 carbon capture cells, 8 carbon capture cells, or 12 carbon capture cells according to aspects of the invention;

FIG. 7A is a graph showing the change in carbon dioxide concentration of the effluent gas over time for the exemplary capacitive carbon capture modules having 2 carbon capture cells in accordance with aspects of the invention;

FIG. 7B is a graph showing the change in carbon dioxide concentration of the effluent gas over time for the exemplary capacitive carbon capture modules having 4 carbon capture cells according to aspects of the invention;

FIG. 7C is a graph showing the change in carbon dioxide concentration of the effluent gas over time for the exemplary capacitive carbon capture modules having 8 carbon capture cells in accordance with aspects of the invention;

FIG. 7D is a graph showing the change in carbon dioxide concentration of the effluent gas over time for the exemplary capacitive carbon capture modules having 12 carbon capture cells according to aspects of the invention;

FIG. 8A is a schematic depicting a system comprising a non-limiting, example of a capacitive carbon capture system in a first carbon capture module is in a charged state and a second carbon capture module is in an uncharged state in accordance with aspects of the invention;

FIG. 8B is a schematic of a non-limiting, example of a capacitive carbon capture system in a first carbon capture module is in a uncharged state and a second carbon capture module is in an charged state according to aspects of the invention;

FIG. 9 is a schematic of a non-limiting, example of a capacitive carbon capture system coupled to a solar panel system in accordance with an aspect of the invention;

FIG. 10 is a schematic of a system comprising a non-limiting, example of a capacitive carbon capture system coupled to a wind turbine system according to an aspect of the invention;

FIG. 11 is a schematic of a non-limiting, example of a capacitive carbon capture system in accordance with an aspect of the invention;

FIG. 12 is scheme of a non-limiting method for capturing carbon utilizing a capacitive carbon capture system according to an aspect of the invention; and

FIG. 13 is a frontal view of the surface of an electrode in accordance with an aspect of the invention;

FIG. 14A is a frontal view of the surface of another electrode according to an aspect of the invention; and

FIG. 14B is a frontal view of the surface of yet another electrode in accordance with an aspect of the invention.

All drawings are not necessarily to scale. Components numbered and appearing in one figure but appearing un-numbered in other figures are the same unless expressly noted otherwise. A reference herein to a whole figure number which appears in multiple figures bearing the same whole number but with different alphabetical suffixes shall be constructed as a general refer to all of those figures unless expressly noted otherwise.

### DETAILED DESCRIPTION

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Aspects of the disclosure are generally directed to carbon capture systems, carbon capture apparatuses, and methods for capturing carbon dioxide from a gas, such as air. The systems and apparatuses disclosed herein may advantageously be capacitive carbon systems and/or capacitive carbon apparatuses. Desirably, the capacitive carbon capture system disclosed herein may advantageously be scaled with minimum or without negative impact on adsorptive performance while having a positive impact on energy consumption. Additionally, certain embodiments of the capacitive carbon capture system have a reduced number of current collectors, which can be a significant cost factor.

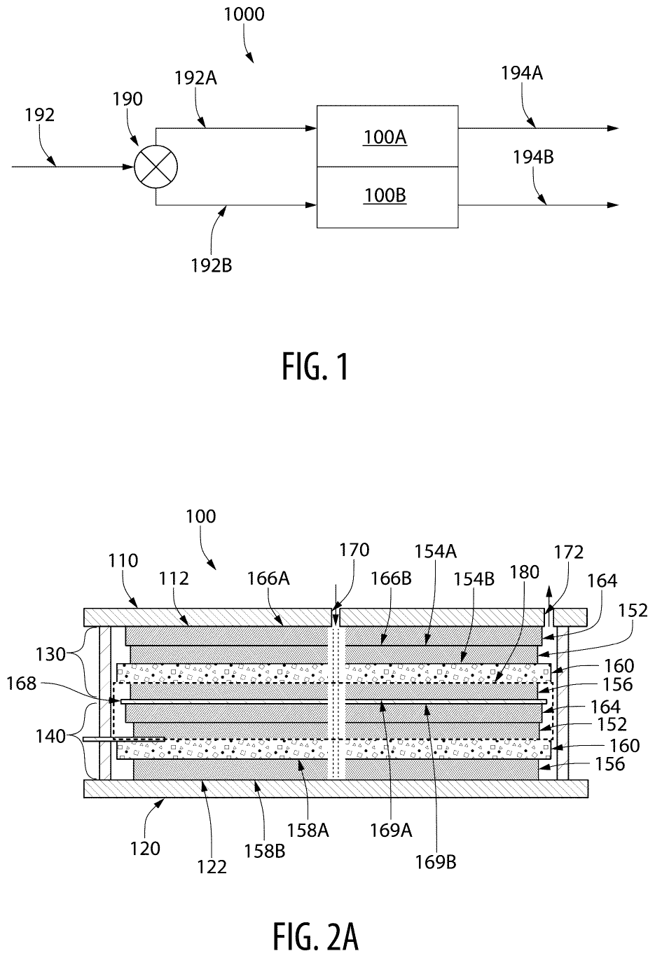

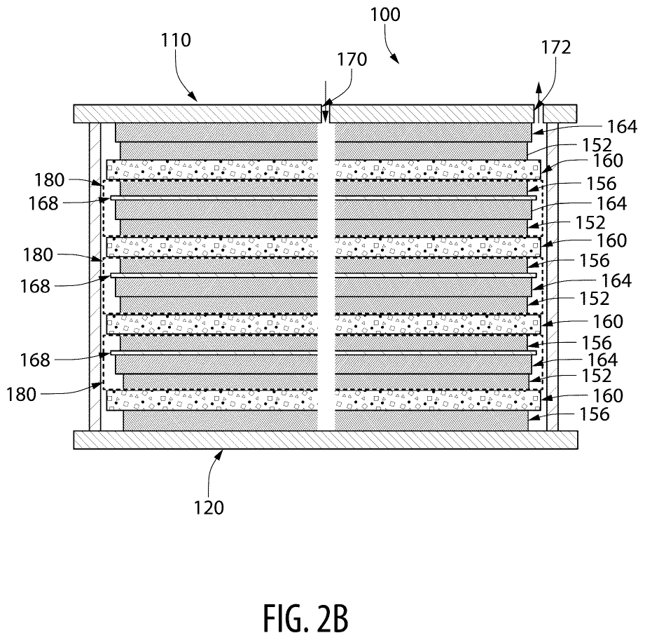

Referring to FIG. 1, provided is a non-limiting example of a capacitive carbon capture system 1000 comprising a carbon capture module 100, such as the carbon capture modules depicted in FIGS. 2A and 2B. As a general overview, capacitive carbon capture system 1000 comprising: one or more carbon capture modules 100 comprising: a first current collector 110 having a surface; a second current collector 120 having a surface and spaced from the first current collector 110; a first carbon capture cell 130 and a second carbon capture cell 140, the first carbon capture cell 130 and the second carbon capture cell 140 each comprising: a first electrode 152 comprising a first surface 154A and a second surface 154B opposed the first surface 154A, a second electrode 156 spaced from the first electrode 152, the second electrode 156 comprising a first surface 158A and a second surface 158B opposed the first surface 158A, an electrolyte solution in contact with the second surface 154B of the first electrode 152 and the first surface 158A of the second electrode 156, and a gas permeable layer 164 comprising a first surface 166A and a second surface 166B opposed to the first surface 166A; and a barrier 168 extending between the first carbon capture cell 130 and the second carbon capture cell 140, the barrier 168 being electrically conductive, and not permeable for ions.

Capacitive carbon capture system 1000 typically comprise a first current collector 110 and a second current collector 120. First current collector 110 and second current collector 120 are typically connected to an electrical source, which preferably is a variable voltage source. First current collector 110 has a surface 112 that may extend along a plane or substantially along a plane.

Second current collector 120 is typically spaced from the first current collector 110. Second current collector 120 has a surface 122 that may extend along a plane or substantially along a plane. Preferably, second current collector 120 extends along a plane that is parallel to the plane that first current collector 110 extends.

First current collector 110 and second current collector 120 typically comprise or are formed of electrically conductive material. In some cases, first current collector 110 and second current collector 120 may independently comprise a metal layer, plate, and/or sheet. For instance, first current collector 110 and second current collector 120 may independently comprise or be made of a material selected from the group consisting of electrically conducting metals, such as but not limited to titanium and aluminum, carbon, electrically conducting polymers, and electrically conducting ceramics. In some embodiments, first current collector 110 and second current collector 120 may, independently, comprise or be formed of a material selected from carbon, titanium, steel, gold, silver, platinum, palladium, aluminum, copper, lead, tin, and electrically conducting polymers, such as but not limited to polyacetylene and polyaniline. In further embodiments, first current collector 110 and second current collector 120 may, independently, comprise or be formed of a material that is resistant to corrosion and/or are chemically inert to one or more gases which can be flowed through the gas permeable layer(s) 164 and are further chemically inert to the electrolyte composition.

Capacitive carbon capture system 1000 includes a plurality of carbon capture cells, which are typically positioned in the space between first current collector 110 and second current collector 120. The plurality of carbon capture cells may comprise from 2 to 1,000 carbon capture cells. For example, carbon capture system 1000 and/or carbon capture module 100 may comprise from 2 to 1,000, 2 to 700, 2 to 400, 2 to 200, 2 to 100, 2 to 50, 2 to 40, 2 to 30, 2 to 20, 2 to 10; from 10 to 1,000, 10 to 700, 10 to 400, 10 to 200, 10 to 100, 10 to 50, 10 to 40, 10 to 30, 10 to 20; from 25 to 1,000, 25 to 700, 25 to 400, 25 to 200, 25 to 100, 25 to 50, 25 to 40; from 50 to 1,000, 50 to 700, 50 to 400, 50 to 200, 50 to 100; from 70 to 1,000, 70 to 700, 70 to 400, 70 to 200, 70 to 100; from 100 to 1,000, 100 to 700, 100 to 400, 100 to 200; from 200 to 1,000, 200 to 700, 200 to 400; from 500 to 1,000, 500 to 700; from 700 to 1,000, or any range in between. In at least one embodiment, carbon capture module 100 may comprise 2, 4, 8, or 12 carbon capture cells.

Carbon capture module 100 typically comprise at least two carbon capture cells, such as first carbon capture cell 130 and second carbon capture 140 shown in FIG. 2A. Carbon capture cells 130 and 140 typically comprise at least a first electrode 152, a second electrode 156, an electrolyte composition in contact with first electrode 152 and second electrode 156, and a gas permeable layer 164. In some embodiments, gas permeable layer 164 may be excluded when, e.g., one or more of the electrodes is configured to have gas flow channel 155, as discussed below.

First electrode 152 comprises a first surface 154A and a second surface 154B that is opposed first surface 154A. First surface 154A and/or second surface 154 may extend in the direction along a plane. In some embodiments, first surface 154A extends along a plane that is parallel to the plane of second surface 154B of first electrode 152. First electrode 152 may be configured to have a uniform thickness. First electrode 152 may be configured to be a positive electrode or a negative electrode.

Second electrode 156 comprises a first surface 158A and a second surface 158B that is opposed first surface 158A. First surface 158A and/or second surface 158B may extend in the direction along a plane. In some embodiments, first surface 158A extends along a plane that is parallel to the plane of second surface 158B of second electrode 156. First electrode 156 may be configured to have a uniform thickness. One or more surfaces 158A and/or 158B of second electrode 156 may extend in the direction along a plane that is parallel to a place of one or more surfaces 154A and/or 154B of first electrode 152. Second electrode 156 may be configured to be a positive or a negative electrode. In certain embodiments, first electrode 152 is configured to be a positive electrode and second electrode 156 is configured to be a negative electrode.

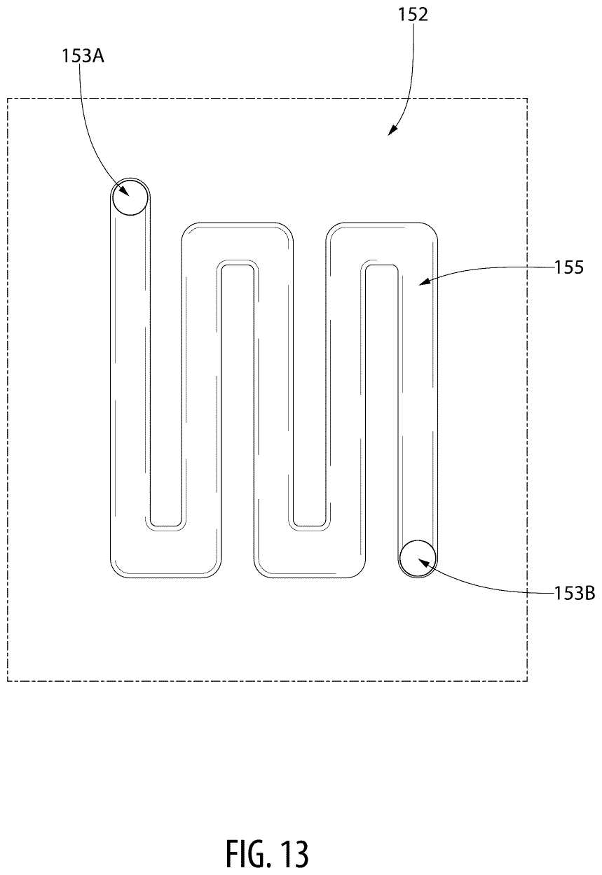

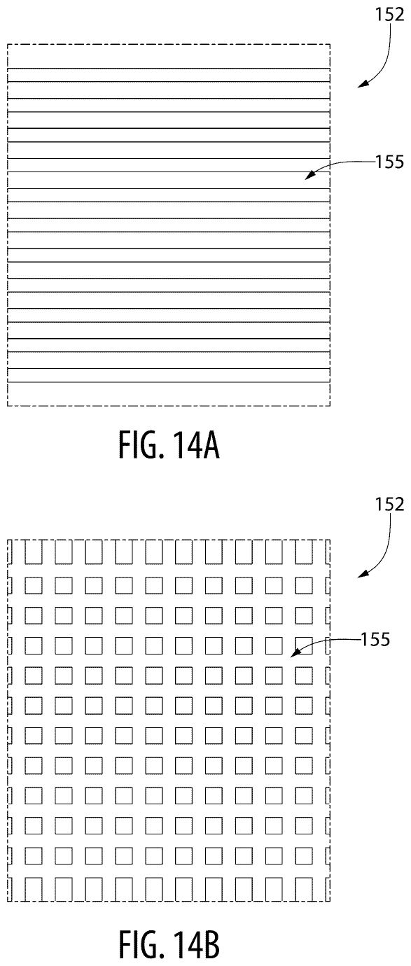

In certain embodiments, one or more of the electrodes has a surface delineating grooves and/or gas flow channels 155 for facilitating gas flow. As seen in FIGS. 13-14B, first electrode 152 may have a gas flow channel 155 defined by an indentation in a surface of first electrode 152. In the embodiment illustrated in FIG. 13, the gas flow channel extends from a first end 153A of gas flow channel 155 to a second end of gas flow channel 153B and forms, e.g., a serpentine gas flow configuration. With reference to FIGS. 14A and 14B, the gas flow channel 155 may be configured to be straight channels (see FIG. 14A) or intersecting straight channels (see FIG. 14B). Although FIGS. 13-14B show a surface of first electrode 152, any of the electrodes of the carbon capture modules 100 and carbon capture systems 1000 may include one or more gas flow channel(s) 155. Additionally, gas flow channel 155 may be delineated by the first surface and/or the second surface of any of the electrodes of the carbon capture modules 100 and carbon capture systems 1000. In certain embodiments, when one or more of the electrodes is configured to have gas flow channel 155, such electrode 155 is not adjacent a gas permeable layer 164. In some embodiments, one or more carbon capture cell of carbon capture module 100 is free of gas permeable layer 164. In at least one embodiment, carbon capture modules 100 and/or carbon capture systems 1000 is configured to be free of gas permeable layer 164.

First electrode 152 and/or second electrode 156 typically comprise and/or are formed of an electrically conductive material. Preferably, first electrode 152 and/or second electrode 156 comprise and/or are formed of a material capable of reversibly adsorbing one or more gases (preferably, carbon dioxide) upon the application of an electrical voltage. One or both of first electrode 152 and second electrode 156 may comprise a porous capacitive and/or pseudocapacitive material. In some embodiments, first electrode 152 and/or second electrode 156, independent, comprise or are formed of a material selected from activated carbons, oxides, sulfides, nitrides, carbides, polymers, or a combination of two or more thereof.

In certain preferred embodiments, one or both of the first electrode and the second electrode comprise or are formed of biomass-derived carbon. The biomass-derived carbon may comprise garlic root derived carbon. For example, one or both of first electrode 152 and second electrode 156 may, independently, comprises or have a layer formed of garlic-root carbon post-treated with air. In certain embodiments, first electrode 152 and second electrode 156 have not been hot pressed. First electrode 152 and/or second electrode 156 may include a layer formed of biomass-derived carbon, such as garlic root derived carbon, where the layer is preferably the outer layer of first electrode 152 and/or second electrode 156, which is exposed to the gaseous feed stream comprising carbon dioxide during operation of carbon capture module 100.

Additionally or alternatively, first electrode 152 and/or second electrode 156, independently, may comprise and/or are formed of a material having a high surface area carbon, e.g. BPL carbon, YP-50F, YP-80F, and Norit DLC-SE30; porous metals e.g. porous forms of titanium; electrically conducting porous metal-organic frameworks, and electrically conducting porous polymers, e.g. TP-COF.

The electrodes may be carbon based (e.g., graphite based), manganese based, iron oxide based, or a combination thereof. One or both of first electrode 152 and second electrode 156 may be configured to have density or an outer layer having a density of about 0.05 up to about 5.2 g/cm³. For example, first electrode 152 and/or second electrode 156 may have a density or have an outer layer having a density of about 0.2 to about 5.2 g/cm³, about 0.2 to about 5.03 g/cm³, about 0.2 to about 4.5 g/cm³, about 0.2 to about 4 g/cm³, about 0.2 to about 3.5 g/cm³, about 0.2 to about 3 g/cm³, about 0.2 to about 2.5 g/cm³, about 0.2 to about 2.26 g/cm³, about 0.2 to about 2 g/cm³, about 0.2 to about 1.5 g/cm³, about 0.2 to about 1 g/cm³; from about 0.5 to about 5.2 g/cm³, about 0.5 to about 5.03 g/cm³, about 0.5 to about 4.5 g/cm³, about 0.5 to about 4 g/cm³, about 0.5 to about 3.5 g/cm³, about 0.5 to about 3 g/cm³, about 0.5 to about 2.5 g/cm³, about 0.5 to about 2.26 g/cm³, about 0.5 to about 2 g/cm³, about 0.5 to about 1.5 g/cm³, about 0.5 to about 1 g/cm³; from about 1 to about 5.2 g/cm³, about 1 to about 5.03 g/cm³, about 1 to about 4.5 g/cm³, about 1 to about 4 g/cm³, about 1 to about 3.5 g/cm³, about 1 to about 3 g/cm³, about 1 to about 2.5 g/cm³, about 1 to about 2.26 g/cm³, about 1 to about 2 g/cm³, about 1 to about 1.5 g/cm³; from about 1.5 to about 5.2 g/cm³, about 1.5 to about 5.03 g/cm³, about 1.5 to about 4.5 g/cm³, about 1.5 to about 4 g/cm³, about 1.5 to about 3.5 g/cm³, about 1.5 to about 3 g/cm³, about 1.5 to about 2.5 g/cm³, about 1.5 to about 2.26 g/cm³, about 1.5 to about 2 g/cm³; from about 2 to about 5.2 g/cm³, about 2 to about 5.03 g/cm³, about 2 to about 4.5 g/cm³, about 2 to about 4 g/cm³, about 2 to about 3.5 g/cm³, about 2 to about 3 g/cm³, about 2 to about 2.5 g/cm³, about 2 to about 2.26 g/cm³; from about 2.26 to about 5.2 g/cm³, about 2.26 to about 5.03 g/cm³, about 2.26 to about 4.5 g/cm³, about 2.26 to about 4 g/cm³, about 2.26 to about 3.5 g/cm³, about 2.26 to about 3 g/cm³, about 2.26 to about 2.5 g/cm³; from about 2.5 to about 5.2 g/cm³, about 2.5 to about 5.03 g/cm³, about 2.5 to about 4.5 g/cm³, about 2.5 to about 4 g/cm³, about 2.5 to about 3.5 g/cm³, about 2.5 to about 3 g/cm³, about 2.5 to about 2.5 g/cm³; from about 3.5 to about 5.2 g/cm³, about 3.5 to about 5.03 g/cm³, about 3.5 to about 4.5 g/cm³, about 3.5 to about 4 g/cm³; from about 4 to about 5.2 g/cm³, about 4 to about 5.03 g/cm³, about 4 to about 4.5 g/cm³; from about 4.5 to about 5.2 g/cm³, about 4.5 to about 5.03 g/cm³; from about 5 to about 5.2 g/cm³, about 5 to about 5.03 g/cm³; from about 5.03 to about 5.2 g/cm³, or any range or subrange thereof.

In some cases, first electrode 152 and/or second electrode 156 may have a density or have an outer layer having a density of about 0.05 to about 0.9 g/cm³, about 0.05 to about 0.7 g/cm³, about 0.05 to about 0.6 g/cm³, about 0.05 to about 0.5 g/cm³, about 0.05 to about 0.4 g/cm³, about 0.05 to about 0.3 g/cm³, about 0.05 to about 0.2 g/cm³, about 0.05 to about 0.1 g/cm³; from about 0.1 to about 0.9 g/cm³, about 0.1 to about 0.7 g/cm³, about 0.1 to about 0.6 g/cm³, about 0.1 to about 0.5 g/cm³, about 0.1 to about 0.4 g/cm³, about 0.1 to about 0.3 g/cm³, about 0.1 to about 0.2 g/cm³; from about 0.15 to about 0.9 g/cm³, about 0.15 to about 0.7 g/cm³, about 0.15 to about 0.6 g/cm³, about 0.15 to about 0.5 g/cm³, about 0.15 to about 0.4 g/cm³, about 0.15 to about 0.3 g/cm³, about 0.15 to about 0.2 g/cm³; from about 0.2 to about 0.9 g/cm³, about 0.2 to about 0.7 g/cm³, about 0.2 to about 0.6 g/cm³, about 0.2 to about 0.5 g/cm³, about 0.2 to about 0.4 g/cm³, about 0.2 to about 0.3 g/cm³; from about 0.25 to about 0.9 g/cm³, about 0.25 to about 0.7 g/cm³, about 0.25 to about 0.6 g/cm³, about 0.25 to about 0.5 g/cm³, about 0.25 to about 0.4 g/cm³, about 0.25 to about 0.3 g/cm³; from about 0.3 to about 0.9 g/cm³, about 0.3 to about 0.7 g/cm³, about 0.3 to about 0.6 g/cm³, about 0.3 to about 0.5 g/cm³, about 0.3 to about 0.4 g/cm³; from about 0.4 to about 0.9 g/cm³, about 0.4 to about 0.7 g/cm³, about 0.4 to about 0.6 g/cm³, about 0.4 to about 0.5 g/cm³; from about 0.5 to about 0.9 g/cm³, about 0.5 to about 0.7 g/cm³, about 0.5 to about 0.6 g/cm³, or any range or subrange thereof.

Carbon capture cells 130 and/or 140 have an electrolyte composition that may be in contact with second surface 154B of first electrode 152 and first surface 158A of second electrode 156. The electrolyte composition preferably is disposed in a separator 160 that is positioned at least partially between first electrode 152 and second electrode 156. Separator 160 may extend between first electrode 152 and second electrode 156 of each of carbon capture cell in carbon capture module 100, e.g., first carbon capture cell 130 and second carbon capture cell 140. Separator 160 may comprise or be formed of a porous material.

Separator 160 is preferably an electrically insulating material (e.g., a non-electronically conductive material) that is ion permeable. For instance, separator 160 is typically adapted to be permeable to the ions of the electrolyte composition and ion derived from carbon dioxide. Preferably, separator 160 may comprises pores that allow for the flow of an electrolyte and/or ions thereof. Separator 160 may have macropores, micropores, and/or nanopores. Separator 160 may comprise or be formed of any electrically insulating separator material known in the art, such as, but not limited to those used in coin-type supercapacitors. In certain embodiments, separator 160 comprises at least one material selected from the group consisting of porous cellulose, porous glass, porous polypropylene, and porous polyethylene, a hydrogel, or an ion-exchange membrane. In certain preferred embodiments, separator 160 comprises or is formed of cellulose, cellulose derived material, and/or modified cellulose material.

The electrolyte composition may comprise about 5 wt. % or more of water and be an electrolyte solution. Preferably, the electrolyte solution comprises a salt that is deliquescent. Example of deliquescent salts that may be incorporated in the electrolyte composition include MgBr₂, MgCl₂, CsF, CaCl₂), KF, CaBr₂, LiCl, LiBr, or a combination thereof. In some embodiments, the electrolyte solution comprises MgBr₂, MgCl₂, CsF, or a combination thereof.

As mentioned above, the electrolyte compositions disclosed herein may preferably exhibit minimal to no evaporation of the electrolyte compositions or electrolyte solutions. For instance, the electrolyte composition may exhibit less than about 3 wt. %, preferably less than 1 wt. %, preferably less than 0.5 wt. %, preferably less than 0.1 wt. %, preferably less than 0.01 wt. %, preferably less than about 0.001 wt. % of the electrolyte composition, relative to the total weight of the electrolyte composition, over a period of time of 3 months when the carbon capture module is operated to remove carbon dioxide from atmospheric air. In some cases, the electrolyte compositions disclosed herein exhibits an amount of evaporation of up to any of the foregoing amounts over a period of time of 6 months, preferably 9 months, preferably 12 months, preferably 2 years, preferably 5 years, preferably 20 years, when the carbon capture module is operated to remove carbon dioxide from atmospheric air. In some cases, the electrolyte compositions include electrolytes selected from those disclosed herein such that the electrolyte composition exhibits no evaporation over a period of time of 6 months, 9 months, 12 months, 2 years, 5 years, or 20 years, if kept in a controlled environment having a temperature between-20 and 80° C. and a relative humidity ranging between 10 and 100%. For example, the electrolyte compositions may include electrolytes selected from those disclosed herein such that the electrolyte composition exhibits no evaporation over a period of time of 6 months, 9 months, 12 months, 2 years, 5 years, or 20 years, if kept in a controlled environment having a temperature of 25° C. and a relative humidity of 70. In at least one preferred embodiment, the electrolyte compositions disclosed herein exhibits no evaporation when the carbon capture module is operated to recover carbon dioxide from air.

Additionally or alternatively, the electrolyte composition may include an electrolyte, such as those used in coin-type super capacitors and fuel cells. The electrolyte composition may comprise at least one ingredient selected from the group consisting of an aqueous or non-aqueous salt solution, such as but not limited to an aqueous solution of NaCl and/or an acetonitrile solution of NEt₄⁺BF₄⁻. In some instances, the electrolyte composition comprises a salt selected from NaCl, LiCl, KCl, Na₂SO₄, Li₂SO₄, K₂SO₄, NaF, LiF, KF, H₂SO₄, H₃PO₄, HCl, NaOH, KOH, LiOH, LiClO₄, NaClO₄, KClO₄, NaPF₆, LiPF₆, NaPF₆, KPF₆, LiBF₄, NaBF₄, KBF₄, tetraalkyl ammonium tetrafluoroborates, chlorides, fluorides, sulfates, perchlorates, and hexafluorophosphates, tetraphosphonium tetrafluoroborates, chlorides, fluorides, sulfates, perchlorates, hexafluorophosphates, or a combination of two or more thereof. Additionally or alternatively, the electrolyte composition may include 1-ethyl-3-methylimidazolium acetate, 1-ethyl-3-methylimidazolium tris(pentafluoroethyl)trifluorophosphate, 1-butyl-3-methylimidazolium bis(perfluoroethylsulfonyl)imide, 1-butyl-3-methylimidazolium bis(fluorosulfonyl)imide, 1-hexyl-3-methylimidazolium bis(trifluoromethylsulfonyl)imide, 1-octyl-3-methylimidazolium bis(trifluoromethylsulfonyl)imide, or a combination of two or more thereof. The electrolyte composition may be an organic solvent-contained (and/or organic solvent-only) salt solution comprising NaCl, LiCl, KCl, Na₂SO₄, Li₂SO₄, K₂SO₄, NaF, LiF, KF, H₂SO₄, H₃PO₄, HCl, NaOH, KOH, LiOH, LiClO₄, NaClO₄, KClO₄, NaPF₆, LiPF₆, NaPF₆, KPF₆, LiBF₄, NaBF₄, KBF₄, tetraalkyl ammonium tetrafluoroborates, chlorides, fluorides, sulfates, perchlorates, and hexafluorphosphates, tetraphosphonium tetrafluoroborates, chlorides, fluorides, sulfates, perchlorates, hexafluorophosphates, or a combination of two or more thereof in an organic solvent, such as but not limited to acetonitrile, gamma-butyrolactone, propylene carbonate, tetrahydrofuran, and diethylcarbonate.

In certain embodiments, separator 160 is in close contact with first electrode 152 and second electrode 156, allowing for capillary forces to draw the electrolyte and/or ions thereof to be adsorbed to with first electrode 152 and/or second electrode 156. Without being limited to any particular theory, this may result in an electric double layer upon electrode charging. In other embodiments, formation of the double layer leads to supercapacitance.

Separator 160, first electrode 152, and second electrode 156 may have identical length and width dimensions and/or about identical length and width dimensions. Separator 106 can be situated between and in physical contact with second surface 154B of first electrode 152 and the first surface 158A of second electrode 156.

Carbon capture cells 130 and/or 140 have a gas permeable layer 164 comprising a first surface 166A and a second surface 166B opposed to the first surface 166A. First surface 166A and/or second surface 166B of gas permeable layer 164 may extend in the direction along a plane. In some embodiments, first surface 166A of gas permeable layer 164 extends along a plane that is parallel to the plane of second surface 166B of said gas permeable layer 164. In some instances, gas permeable layer 164 may be configured to have a uniform thickness. Gas permeable layer 164 can be situated adjacent to and in physical contact with first surface 154A of the first electrode 152.

Gas permeable layer 164 may comprise or be formed of a material that allows for the passage of gases therethrough, e.g., to allow gases to come in contact with first surface 110 of first electrode 152. For instance, gas permeable layer 164 may be an electrically conducting material, which is permeable to a gas. Gas permeable layer 164 may be porous. Gas permeable layer 164 may have macropores, micropores, and/or nanopores in some cases. In certain embodiments, gas permeable layer 164 comprises one or more materials selected from carbon cloth, carbon mesh, carbon felt, carbon paper, metallic foam, metallic mesh, metallic paper, or a combination thereof. Although FIG. 1 illustrates an embodiment that comprises gas permeable layer 164, in some embodiments carbon capture module 100 does not include a gas permeable layer, such as, e.g., in embodiments where one or more electrode has grooves and/or gas flow channels delineated by a surface of the electrode for facilitating gas flow.

Carbon capture module 100 typically comprises a barrier 168 extending between first carbon capture cell 130 and second carbon capture cell 140. Barrier 168 is typically configured to be electrically conductive and non-permeable for ions. As seen in the embodiments shown in FIGS. 2A and 2B, barrier 168 may extend adjacent second surface 158B of second electrode 156 of first carbon capture cell 130 and adjacent first surface 166A of gas permeable layer 164 of the second carbon capture cell 140. In some embodiments, carbon capture module 100 is configured such that barrier 168 has a first surface 169A and a second surface 169B, wherein the barrier 168 is configured to prevent movement of ions from first carbon capture cell 130 to second carbon capture cell 140 and/or from second carbon capture cell 140 to first carbon capture cell 130.

The barrier may comprise or be formed of metal, ion-impermeable carbons (such as ion-impermeable activated carbons), oxides, sulfides, nitrides, carbides, polymers, or a combination of two or more thereof. In at least one preferred embodiment, the barrier comprises or is formed of titanium, copper, silver, aluminum, tin, steel, any alloy thereof, an electrically conductive polymer (e.g., a polymer infused with carbon), graphite, or any combination of two or more thereof. The barrier can be an electrically conductive material that is not porous.

Carbon capture module 100 may be configured such that first carbon capture cell 130 and second carbon capture cell 140 may, in some embodiments, be positioned at least partially in the space between first current collector 110 and second current collector 120. In some embodiments, carbon capture module 100 may be configured such that first current collector 112 is in physical contact and spans gas permeable layer 164 distal to first surface 154A of first electrode 152 and second current collector 120 is in physical contact and spans second surface 166B of second electrode 164. First surface 166A of the gas permeable layer 164 of first carbon capture cell 130 may extend adjacent to surface 112 of first current collector 110 and second surface 158B of second electrode 156 of second carbon capture cell 140 extends adjacent to surface 122 of second current collector 120. In some instances, second surface 166B of gas permeable layer 164 extends adjacent to first surface 154A of first electrode 152.

Carbon capture module 100 may further include a feed inlet conduit 170. Feed inlet conduit 170 may extend transversally through first and second surface 166A and 166B of gas permeable layer 164 of first carbon capture cell 130 and extending transversally through first and second surface 166A and 166B of gas permeable layer 164 of the second carbon capture cell 140. In some embodiments, feed inlet conduit 170 extends perpendicularly through first and second surface 166A and 166B of gas permeable layer 164 of first carbon capture cell 130 and extending perpendicularly through first and second surface 166A and 166B of gas permeable layer 164 of the second carbon capture cell 140.

Carbon capture module 100 may further include a feed outlet conduit 172. Feed outlet 172 may extend transversally through first and second surface 166A and 166B of gas permeable layer 164 of first carbon capture cell 130 and extending transversally through first and second surface 166A and 166B of gas permeable layer 164 of the second carbon capture cell 140. In some embodiments, feed outlet 172 extends perpendicularly through first and second surface 166A and 166B of gas permeable layer 164 of first carbon capture cell 130 and extending perpendicularly through first and second surface 166A and 166B of gas permeable layer 164 of the second carbon capture cell 140. Feed out 172 may be configured to receive the feed outlet stream 194 from carbon capture module 100.

Carbon capture module 100 is preferably configured to comprise a bipolar electrode 180. For instance, carbon capture module 100 may be configured such that first carbon capture cell 130, second carbon capture cell 140, and barrier 168 extending therebetween form a bipolar electrode 180. Bipolar electrode 180 may be formed first carbon capture cell 130, second carbon capture cell 140, barrier 168, and gas permeable layer 164 of one of the first carbon capture cell 130 and/or second carbon capture cell 140. For instance, in the embodiment shown in FIG. 2A, bipolar electrode 180 comprises second electrode 156 of first carbon capture cell 130, barrier 168 (which is preferably electrically conductive), gas permeable layer 164 of second carbon capture cell 140, and first electrode 152 of second carbon capture cell 140. Although barrier 168 in the embodiment shown in FIG. 2A is electrically conductive, barrier 168 is not in electrical communication with an electrical source, such as an electrical source that would directly apply an electrical current and/or voltage to said barrier 168. In some embodiments, carbon capture module 100 is configured such that one of the electrodes forming bipolar electrode 180 is a positively charged electrode and the other electrode forming the bipolar electrode 180 is negative charged electrode, e.g., when a voltage is applied to charge carbon capture module 100. In some preferred embodiments, carbon capture module 100 is configured to comprise a number of bipolar electrodes that is one less than the total number of carbon capture cells in carbon capture module 100.

The inventors advantageously discovered that carbon capture modules disclosed herein having certain components and arrangements thereof can have a reduce number of current collectors. For instance, carbon capture module 100 may be configured to be free of a third current collector. In some embodiments, each carbon capture module 100 in carbon capture system 100 is free of a third current collector. The carbon capture module 100 may be configured to consist of two current collectors (e.g., first current collector 110 and second current collector 130). Carbon capture system 100 may be configured such that each of the capture modules consists of two current conductors. In certain embodiments, carbon capture module 100 may be configured such that first and second carbon capture cells 130 and 140 are each in election connection with only one current collector, e.g., one of first current collector 110 or second current collector 120.

Capacitive carbon capture module 100 may, in some cases, include one or more corrosion resistant layers. For example, a first corrosion resistant layer may optionally be situated between the first current collector 110 and the gas permeable layer 164, such that a first surface of the corrosion resistant layer is in contact with the first current collector 110 and a second surface of the said corrosion resistant layer is in contact with the gas permeable layer 164. In some embodiments, capacitive carbon capture system 100 includes a second corrosion resistant layer that may be situated between the second electrode 140 and the second current collector 120, such that a first surface of the second corrosion resistant layer is in contact with the second surface 158B of the second electrode 156 and a second surface of the second corrosion resistant layer is in contact with the second current collector 120. Without being limited to any specific purpose, the corrosion resistant layers may serve to protect and prevent corrosion of one or more layers selected from first and second current collectors 110 and 120, first and second electrodes 130 and 140, and/or gas permeable layer 164. In certain embodiments, a first corrosion resistant layer is in physical contact and spans the surface 112 of the first current collector 110 and a second corrosion resistant layer is in physical contact and spans the surface 122 of the second current collector.

The corrosion resistant layers may independently comprise one or more materials selected from the group consisting of graphite, titanium, gold, silver, platinum, electrically conducting polymers, stainless steel, alloy steel, electrically conducting ceramics, electrically conducting plastics and any combinations thereof. In some embodiments, the first and second corrosion resistant layers independently further comprise one or more materials selected from the group consisting of corrosion resistant plastics, corrosion resistant ceramics and any combinations thereof.

Capacitive carbon capture module 100 may further comprise a gasket. In certain embodiments, the gasket has a thickness that is approximately the sum of the thicknesses of gas permeable layer(s) 164, first electrode(s) 130, second electrode(s) 140 and separator 160 of one or all of the carbon capture cells in carbon capture module 100. In certain embodiments, carbon capture module 100 comprises one or more electrically insulating gaskets 122.

In some cases, the gasket(s) may form a seal around one or more of the carbon capture cells, including, e.g., around at least one of the gas permeable layer 164, separator 160 comprising an electrolyte composition, first electrode 152, second electrode 156, optionally first and/or second corrosion resistant layer if present, and optionally a second gas permeable layer 164 if present, of first carbon capture cell 130 and second carbon capture cell 140. In certain embodiments, the gasket forms a seal around each of the carbon capture cells in carbon capture module 100. The gasket may form a seal against liquid and gas exchange around one or more layers. In certain embodiments, the gasket serves to form an enclosed system, externally bounded by the first current collector 110, the gasket, and second current collector 120. In further embodiments, the gasket forms a sealed preventing liquid and gas exchange except for gases passing through the feed inlet conduit 170, feed outlet conduit 172, and/or gas to and from the gas permeable layers 164. Additional disclosure of the gasket or the implementation of the gasket in the carbon capture module and/or carbon capture cells may be found in U.S. Pat. No. 10,646,813, which is incorporated herein in its entirety for all purposes.

Carbon capture module 100 may include a frame configured to retain one or more components of carbon capture module 100 in place. For instance, carbon capture module 100 may have a frame and two gaskets at the end. One of ordinary skill in the art would recognize suitable materials for the frame.

As illustrated in FIG. 1, carbon capture system 1000 comprises a first carbon capture module 100A, a second carbon capture module 100B, a feed stream 192, a valve 190, and effluent streams 194A and 194B. Feed stream 192 is preferably a gaseous feed stream comprising carbon dioxide. Feed stream 194 is preferably in fluidic communication with feed inlet conduit 170. Feed stream 192 preferably comprises carbon dioxide in an amount of about 300 ppm or more. While carbon capture system 100 is not particularly limited to use with feed streams having a particular amount of carbon dioxide, in certain embodiment feed stream 192 comprises carbon dioxide in an amount from about 300 ppm to 18 vol. % relative to the total volume of the feed stream. For example, feed stream 192 may comprise carbon dioxide in an amount from about 300 to about 900 ppm, about 300 to about 700 ppm, about 300 to about 500 ppm, about 300 to about 450 ppm, about 300 to about 400 ppm; from about 350 to about 900 ppm, about 350 to about 700 ppm, about 350 to about 500 ppm, about 350 to about 450 ppm, about 350 to about 400 ppm; from about 400 to about 900 ppm, about 400 to about 700 ppm, about 400 to about 500 ppm, about 400 to about 450 ppm, or any range or subrange thereof. In some cases, feed stream 192 may comprise carbon dioxide in an amount from about 1 to about 18 vol. %, about 1 to about 15 vol. %, about 1 to about 12 vol. %, about 1 to about 9 vol. %, about 1 to about 6 vol. %, about 1 to about 4 vol. %, about 1 to about 2 vol. %; from about 3 to about 18 vol. %, about 3 to about 15 vol. %, about 3 to about 12 vol. %, about 3 to about 9 vol. %, about 3 to about 6 vol. %, about 3 to about 4 vol. %; from about 5 to about 18 vol. %, about 5 to about 15 vol. %, about 5 to about 12 vol. %, about 5 to about 9 vol. %, about 5 to about 6 vol. %; from about 8 to about 18 vol. %, about 8 to about 15 vol. %, about 8 to about 12 vol. %, about 8 to about 9 vol. %; from about 11 to about 18 vol. %, about 11 to about 15 vol. %, about 11 to about 12 vol. %; from about 14 to about 18 vol. %, about 14 to about 16 vol. %, or any range subrange thereof, relatively to the total volume of the feed stream. In at least one preferred embodiment, the feed stream comprises about 400 ppm of carbon dioxide. The feed stream 192 may comprise or be atmospheric air.

Feed stream 192 may comprise or be selected from mixtures may be for example CO₂/CH₄, CH₄/N₂, CO₂/H₂, N₂/O₂, alkanes/olefins and so forth. In other embodiments, the feed stream may comprise gaseous compounds selected from the group consisting of CO₂, N₂, O₂, SO₂, SO₃, H₂S, NO, NO₂, NO₃, H₂, CH₄, CO, NH₃, PH₃, AsH₃, NF₃, PF₃ He, Ne, Ar, Kr, Xe, boranes, silanes, and hydrocarbon, fluorocarbon, chlorocarbon, iodocarbon gases, or a combination of two or more thereof. In certain preferred embodiments, the feed stream is air or comprises air.

Although FIG. 1 illustrates an embodiment having only two carbon capture modules 100, in some embodiments carbon capture system 1000 comprises one carbon capture module 100 or comprises a plurality of carbon capture modules 100 of more than two carbon capture modules 100, e.g., three or more, four or more, five or more, six or more, seven or more, eight or more, nine or more, or ten or more carbon capture modules 100. Carbon capture system 1000 may be configured such that the plurality of carbon capture modules 100 are operated in pairs. When carbon capture system 100 comprises more than one carbon capture module 100, preferably carbon capture system 100 includes an optional valve 190. For example, carbon capture system 1000 may be configured to have one or more value 190 configured to either permit or prohibit a feed stream 192 from flowing to one or more of the carbon capture modules 100. In some cases, value 190 is configured to permit feed stream 192 from flowing to one of the pair of carbon capture modules 100 while prohibiting feed stream 192 from flowing to the other of the pair carbon capture modules 100. Carbon capture system 100 may, optionally, include a valve that is position permit or prohibit feed stream 192A, which is coupled to and in fluid communication with first carbon capture module 100A. Capture system 1000 may also include a valve that is position permit or prohibit feed stream 192B, which is coupled to and in fluid communication with second carbon capture module 100B. Carbon capture system 1000 may be configured such that the plurality of carbon capture modules 100 are operated in pairs, where a feed stream may be received by one of the pair of carbon capture modules 100 or diverted to the other of the pair of carbon capture modules 100.

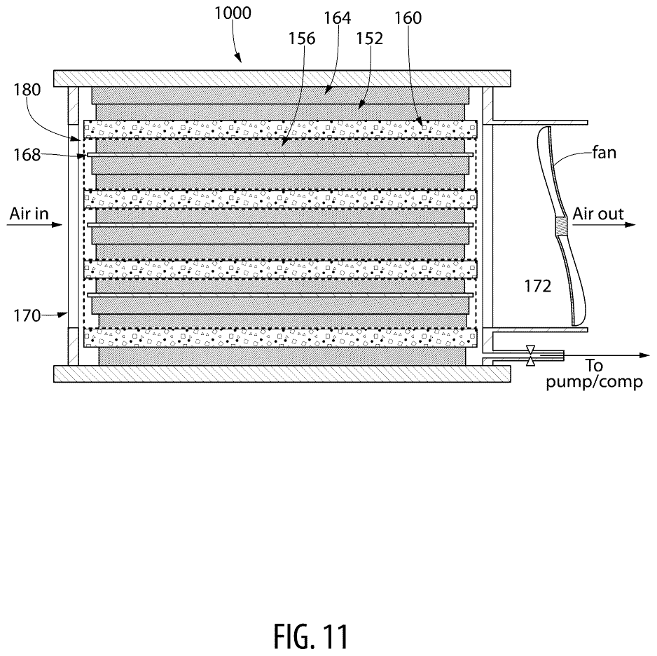

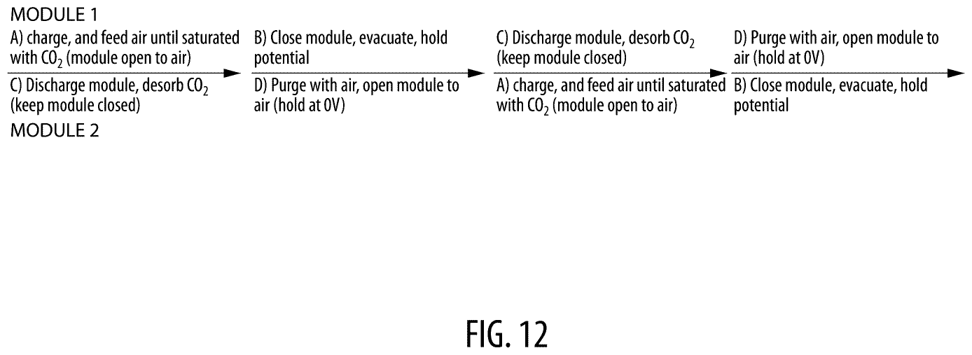

Carbon capture system 1000 may, in some cases, be free of valve 190. For instance, as seen in FIG. 11, carbon capture system 1000 may include a fan for facilitate flow of air into and out of carbon capture system 1000. While FIG. 11 illustrates a carbon capture system 1000 having a single carbon capture module, carbon capture system 1000 may include more than one carbon capture module 100. Although the fan is illustrated in FIG. 11 as being coupled to and/or in fluidic communication with feed outlet 172, the fan (or an additional fan may be coupled to and/or in fluidic connection with feed inlet 170.

Carbon capture system 1000 is preferably configured for selective and reversible adsorption and desorption of carbon dioxide by capacitive charging and capacitive discharging of the electrodes in carbon capture modules 100. The electrodes in the carbon capture modules may be capacitively charged by applying electricity to produce a voltage potential between at least two electrodes of, e.g., about 1 V. In some embodiments, the electrodes may be charged by applying a electricity to produce a voltage potential of about 0.1 to about 15 V, about 0.1 to about 12 V, about 0.1 to about 9 V, about 0.1 to about 6 V, about 0.1 to about 5 V, about 0.1 to about 4 V, about 0.1 to about 3 V, about 0.1 to about 2 V, about 0.1 to about 1 V; from about 0.4 to about 15 V, about 0.4 to about 12 V, about 0.4 to about 9 V, about 0.4 to about 6 V, about 0.4 to about 5 V, about 0.4 to about 4 V, about 0.4 to about 3 V, about 0.4 to about 2 V, about 0.4 to about 1 V; from about 0.7 to about 15 V, about 0.7 to about 12 V, about 0.7 to about 9 V, about 0.7 to about 6 V, about 0.7 to about 5 V, about 0.7 to about 4 V, about 0.7 to about 3 V, about 0.7 to about 2 V, about 0.7 to about 1 V; from about 1 to about 15 V, about 1 to about 12 V, about 1 to about 9 V, about 1 to about 6 V, about 1 to about 5 V, about 1 to about 4 V, about 1 to about 3 V, about 1 to about 2 V; from about 2 to about 15 V, about 2 to about 12 V, about 2 to about 9 V, about 2 to about 6 V, about 2 to about 5 V, about 2 to about 4 V, about 2 to about 3 V; from about 3 to about 15 V, about 3 to about 12 V, about 3 to about 9 V, about 3 to about 6 V, about 3 to about 5 V, about 3 to about 4 V; from about 5 to about 15 V, about 5 to about 12 V, about 5 to about 9 V, about 5 to about 6 V; from about 8 to about 15 V, about 8 to about 12 V, about 8 to about 9 V; from about 11 to about 15 V, about 11 to about 13 V, or any range or subrange thereof. The applied voltage potential may be scaled based at least on the number of carbon capture cells.

During the capacitive charging of the carbon capture module 100, carbon dioxide dissolves in the electrolyte composition and hydrolyzes to form cations/protons and anions (e.g., carbonate and/or bicarbonate anions). The cations/protons and anions obtained from the carbon dioxide may then be adsorbed to the respective electrodes in contact with the electrolyte composition. For instance, the proton/cation may be adsorbed to second electrode 156, which may be configured to be a negative electrode. Additionally or alternatively, the anion may be adsorbed to first electrode 152, which may be configured to be a positive electrode. In some embodiments, one of the proton/cation or the anion may remain the electrolyte composition and not be adsorbed to the respective electrode. The carbon capture system 100 may be configured such that feed stream 192 comprising carbon dioxide is provided to carbon capture module 100 until and/or such that the electrodes are saturated with respective ions of the carbon dioxide.

During capacitive discharge, the adsorbed ions are released into the electrolyte composition, whereby the ions recombine to form gaseous carbon dioxide. In some embodiments, capacitive discharging may occur removing the potential voltage across electrodes of the carbon capture module 100.

With reference to FIG. 1, first carbon capture module 100A and second carbon capture module 100B may be configured to be capacitively charged by applying a voltage to the respective carbon capture module 100. In some embodiments, first carbon capture module 100A and second carbon capture module 100B are configured to be alternately capacitively charged. Capacitively charging first carbon capture module 100A and/or second carbon capture module 100B comprises absorbing carbon dioxide from feed stream 192 into the electrolyte composition of the respective carbon capture module 100, wherein the carbon dioxide absorbed in the electrolyte composition hydrolyzes to form a cation and an anion. Capacitively charging one of the carbon captures 100 (e.g., first carbon capture module 100A or second carbon capture module 100B) further comprises the cation or the anion being adsorbed to first electrode 152 of the carbon capture cells of the respective carbon capture module 100. In some instances, charging first carbon capture module 100A and/or second carbon capture module 100B further comprises the cation or the anion being adsorbed to second electrode 156. For example, when a voltage is applied to first electrode 152 and second electrode 156 of respective carbon capture module 100, the cation is adsorbed to one of first electrode 152 or second electrode 156 and the anion is adsorbed to the other of first electrode 152 or second electrode 156.

Carbon capture modules 100 are typically configured for being capacitively discharged. Capacitively discharging one of first carbon capture module 100A or second carbon capture module 100B preferably desorbs the ions of the carbon dioxide and releases gaseous carbon dioxide. For instance, in some embodiments, capacitively discharging first carbon capture module 100A and/or second carbon capture module 100B comprises releasing the adsorbed cation and/or anion from the respective electrode. In some embodiments, carbon capture system 1000 is configured such that carbon capture module 100A may be capacitively charging while carbon capture module 100B is capacitively discharging. Additionally, carbon capture system 1000 may be configured such that carbon capture module 100A is capacitively discharging while carbon capture module 100B is capacitively charging.

Carbon capture system 1000 may be configured such that the electricity associated with discharging the first carbon capture module or the second carbon capture module is delivered to the electrical grid. Accordingly, in some embodiments, higher-priced electricity can be provided to the electrical grid when the grid lacks electrical energy. When the electrical grid has a surplus of lower priced electricity, the energy this energy may be used for capacitively charging the first or the second carbon capture module. Capacitive carbon capture system 100 may be configured to be positioned within a wall, a fence, or part of a structure. Additional disclosure relating to implementation, construction, and/or potential components of the carbon capture systems disclosed herein can be found in U.S. Pat. No. 10,646,813, which is incorporated herein in its entirety for all purposes.

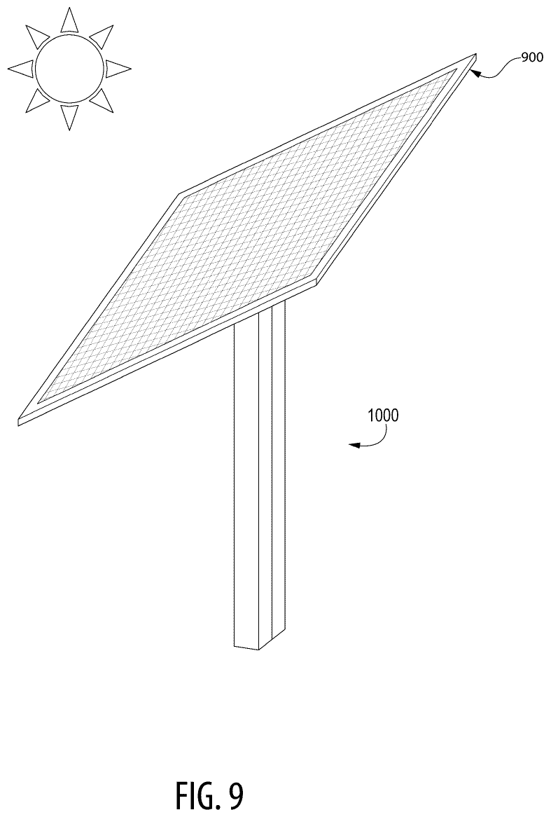

Referring to FIG. 9, a carbon capture system disclosed herein (e.g., carbon capture system 1000) may be configured as at least a portion of a solar panel assembly. In some embodiments, carbon capture system 1000 is integrated into and/or forms at a portion of a solar panel assembly. The solar panel assembly may comprise solar panels 900, which are configured to convert solar light into electricity. Further disclosure of solar panel assemblies and components thereof is disclosed in U.S. Pat. No. 8,234,824, which is incorporated herein by reference in its entirety for all purposes.

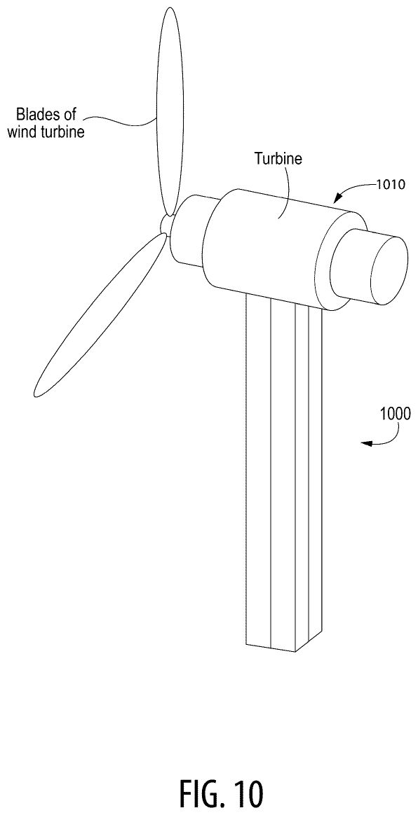

Referring to FIG. 10, a carbon capture system disclosed herein (e.g., carbon capture system 1000) may be configured as at least a portion of a wind turbine assembly. In some embodiments, carbon capture system 1000 is integrated into and/or forms at a portion of a wind turbine assembly. The wind turbine assembly may comprise wind turbine blades 1010, which are configured to convert wind into electricity. Further disclosure of windmill assemblies and components thereof is disclosed in U.S. Pat. Nos. 7,952,215 B, 7,952,215 B, and 7,772,713 B, which are incorporated herein by reference in their entireties for all purposes.

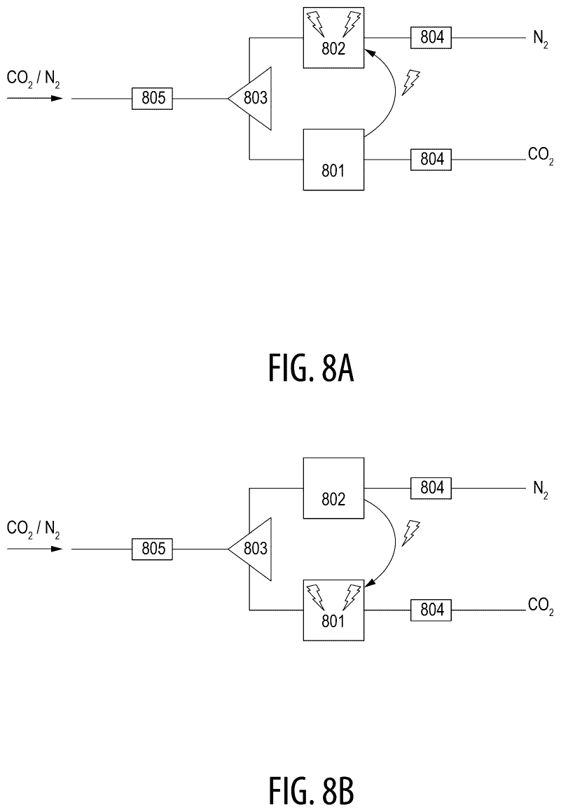

Referring to FIG. 8, provided is a schematic of a system for carbon capture. The methods disclosed herein may employ one or more of carbon capture modules (such as, carbon capture modules 100) and/or carbon capture systems (such as, carbon capture system 1000) disclosed herein. In certain embodiments, the methods remove carbon dioxide from a feed stream, preferably a gaseous feed stream. The feed stream may comprise or be air.

In one example, provided is a method for reversibly adsorbing and desorbing a gaseous compound, preferably carbon dioxide, from a gaseous feed stream. The method may comprise the steps of: providing the feed stream to the first carbon capture module; capacitively charging the first carbon capture module; prohibiting flow of the feed stream to the first carbon capture module; optionally, evacuating the first carbon capture module to reach a pressure of about 0.1 to about 0.3 atmosphere; capacitively discharging the first carbon capture module; providing the feed stream to the second carbon capture module; capacitively charging the second carbon capture module; and optionally releasing gaseous CO₂ from the first carbon capture module.

By way of another example, the method may comprise: providing a carbon capture module (such as those disclosed herein) having at least two electrodes, the carbon capture module further comprising: an electrolyte in contact with the electrode; contacting the first electrode with a gaseous feed stream, the gaseous feed stream comprising carbon dioxide; and reversibly providing an electric charge to the carbon capture module to selectively adsorb the carbon dioxide from the gaseous feed stream. The method may comprise introducing a gaseous feed stream to a carbon capture module (such as those disclosed herein), such that the gaseous feed stream flows through the gas permeable layer; applying a charge to the first and second electrode, wherein the first electrode selectively adsorbs carbon dioxide from the gaseous feed stream; flushing the gaseous feed stream from the apparatus; removing the applied charge from the first and second electrode, wherein the first electrode desorbs the adsorbed gas; and venting the desorbed gas from the carbon capture module.

In certain embodiments, the method comprises flowing the gaseous feed stream comprising carbon dioxide through a carbon capture module disclosed herein, wherein a varying voltage is applied to the first and second current collector (or electrode adjacent to current collector). In other embodiments, the gaseous feed stream feed stream comprises carbon dioxide and another compound having different absorptivities in the carbon capture module when the voltage is applied to the first and second electrode adjacent to the current collectors of the carbon capture module. In some embodiments, the electrodes are charged capacitively while voltage is applied.

It can be anticipated from the design principles of the carbon capture systems 1000 described herein (e.g., carbon capture system) that any feed stream may comprise various gas compounds, the only requirement being that the applied voltage does not alter the absorptivity of the gases in the gaseous mixture of the gaseous feed stream in an identical way. Such gas mixtures may be for example CO₂/CH₄, CH₄/N₂, CO₂/H₂, N₂/O₂, alkanes/olefins and so forth. In other embodiments, the feed stream may comprise gaseous compounds selected from the group consisting of CO₂, N₂, O₂, SO₂, SO₃, H₂S, NO, NO₂, NO₃, H₂, CH₄, CO, NH₃, PH₃, AsH₃, NF₃, PF₃ He, Ne, Ar, Kr, Xe, boranes, silanes, and hydrocarbon, fluorocarbon, chlorocarbon, iodocarbon gases, alkanes, olefins, or a combination of two or more thereof. In certain preferred embodiments, the feed stream is air or comprises air. Although the carbon capture systems 1000 described herein are typically configured for carbon capture, the systems 1000 described herein may be used for separating gas mixtures and/or feed streams that do not contain carbon dioxide and/or for capturing gaseous compounds other than carbon dioxide from a gaseous mixture and/or feed stream. As noted above, the systems 1000 described herein may separate gas mixtures and/or feed streams, the only requirement being that the applied voltage does not alter the absorptivity of the desired gas to be captured in an identical way as other gaseous compound(s) in the gaseous mixture of the gaseous feed stream. Further description of how to utilize the systems 1000 and/or modules 100 described herein for separating gas mixtures and/or streams, which do not contain carbon and/or to capture gaseous compounds other than carbon dioxide can be found in U.S. Pat. No. 10,646,813, which is incorporated herein in its entirety for all purposes.

In certain embodiments, the carbon capture systems disclosed herein, carbon capture modules disclosed herein, and methods thereof are of particular interest because they are capable of operating at high efficiency. In one aspect, the carbon capture modules disclosed herein minimize energy loss due to electrolyte resistance. By using a thin separator layer soaked with an electrolyte instead of a bulk electrolyte solution, energy loss due to resistance is largely negated. In another aspect, the carbon capture modules disclosed herein do not require the use of any moving parts. The carbon capture modules disclosed herein may operate through the application and removal of an applied voltage and the use of flowing gas streams and no moving parts are needed, minimizing energy cost. In yet another aspect, the carbon capture modules disclosed herein may operate quickly due to the use of a gas permeable layer, whereby the gas does not need to be dissolved in a liquid before being fed into the system. By using a gaseous feed stream, the gas which is to be adsorbed can move quickly through the gas permeable layer and come in contact with the adsorbing electrode. Similarly, the gaseous feed stream can be desorbed and vented or flushed more easily by not needing to re-dissolve in an electrolyte solution in order to exit the carbon capture module. Further, by using gas flow instead of an electrolyte solution, the desorbed gas does not need to be actively removed or separated from the electrolyte solution. In yet another aspect, the carbon capture modules disclosed herein are highly scalable by means which could be envisioned by those skilled in the art.

As used herein, the term “about” will be understood by persons of ordinary skill in the art and will vary to some extent on the context in which it is used. As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

As used herein, the term “BPL carbon” refers to a BPL 4×6 Carbon, a commercial activated carbon product produced by the Calgon Company. It is a bituminous coal-based product activated using high temperature in a controlled atmosphere. It is electrically conducting and chemically stable in aqueous and non-aqueous electrolytes.

As used herein, the term “TP-COF” is a highly ordered organic framework consisting of pyrene and triphenylene functionalities alternatively linked in a mesoporous hexagonal skeleton.

As used herein, two or more components in “fluidic” communication can exchange gases and/or liquids among them.

### EXAMPLES

### Example 1

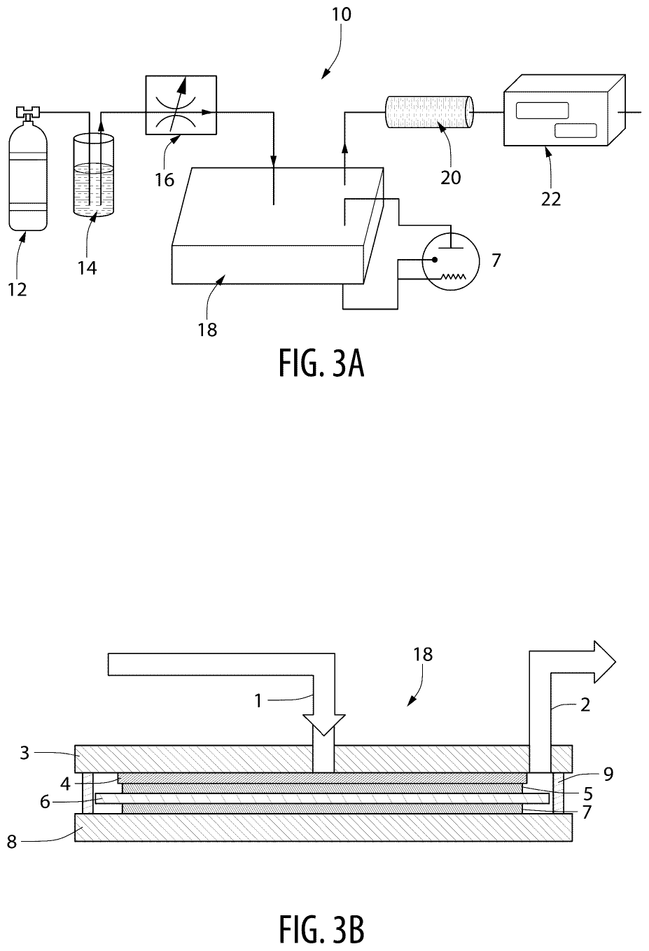

A capacitive carbon capture system was employed to recover carbon dioxide from a gaseous stream comprised of 400 ppm of carbon dioxide with the remainder being atmospheric nitrogen (N₂). A schematic of the experimental set-up employed is shown in FIG. 3A. The experimental set-up included a carbon capture module as depicted in FIG. 3B.

Specifically, a gaseous feed stream having a composition of 400 ppm of carbon dioxide with the remainder being N₂ was continuously fed from a gas cylinder 12 through a bubbler containing the electrolyte solution 14 to moisten the gas mixture and avoid evaporation of the electrolyte in the module. The gaseous feed stream was then fed through a mass flow controller 16 that was adjusted to a specific flow rate that varied between 10 and 32 sccm/min. The gaseous stream was fed next through and carbon capture module 18 with a radial flow system. A schematic of carbon capture module 18 is shown in FIG. 3B. Carbon capture module 18 include a first current collector 3, a second current collector 8, a gas permeable layer 4, a first electrode 5, a second electrode 7, a separator 6, and a gasket 9. The components of carbon capture module 18 are disclosed elsewhere herein.

The gaseous stream was fed into the center of the gas mixture from which it flew radially through the gas permeable layer inside the carbon capture module 18 to the periphery of the carbon capture module 18. The gaseous stream left the carbon capture module 18 at the periphery of carbon capture module 18, and was then fed to a gas drying to tube 20 to protect the gas analyzer from moisture. The effluent gas was then fed into the gas analyzer 22 that measure the CO₂ concentration in the gas mixture as a function of time. The gas analyzer was able measure CO₂ concentrations ranging from 0 to 2000 ppm. The carbon capture module 18 was electrically connected to a galvanostat that charged the carbon capture module 18 at a constant current of 50 mA to a voltage of 1 V. Afterwards, the voltage was held for a specific time that varied between 100 min and 30 hours, depending on the specific experiment conducted. After that carbon capture module 18 was discharged at 50 mA to 0 V, and held at this potential at a specific time that varied between 100 min and 30 hours depending on the specific experiment conducted.

The carbon capture module 18 contained a pair of activated carbon electrodes, which were either purchased, or self-prepared using garlic root derived activated carbon. For the preparation of electrodes, the activated carbon was mixed with PTFE, gluten, and carbon black in a specific weight ratio of 80:5:10:5, whereby the gluten and the PTFE acted as binders, and the carbon black acted as a conductive additive. Briefly, 0.415 g PTFE dispersion, 4.0 g carbon, 0.5 g gluten, and 0.25 g conductive carbon black were dispersed in 50 ml ethanol by sonication. The mixture was stirred in a closed vial at a temperature of 65° C. for 2 hours, and then heated to a temperature of 80° C. to evaporate ethanol until the mixture became a slurry. The slurry was transferred to a flat glass panel and mixed thoroughly using metal spatulas to become a sticky dough-like substance. Then, the dough was processed through a pasta machine to produce flat sheets of 0.6 to 0.7 mm thickness. Two 7 cm×7 cm sheets were then cut and dried at 100° C. and ~25 mmHg overnight in a vacuum oven to remove residual solvent.

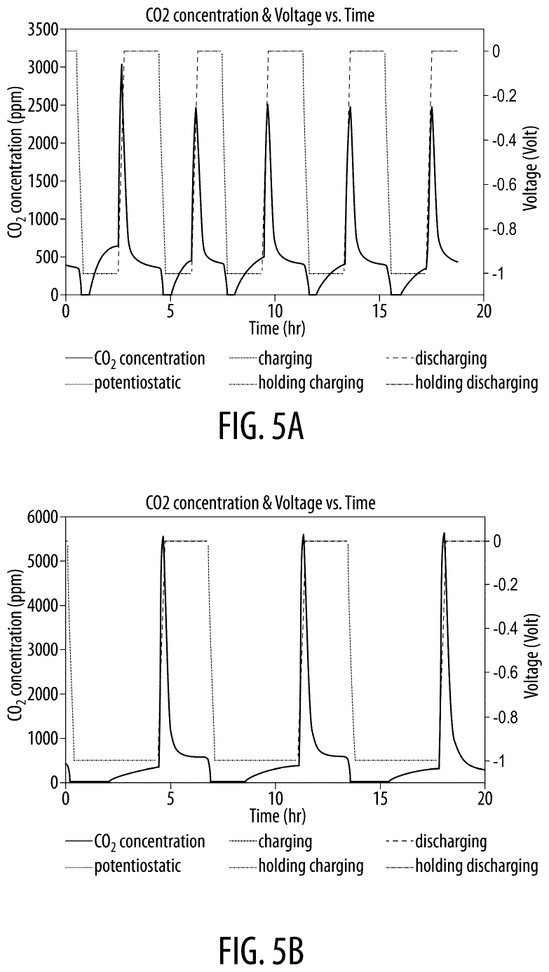

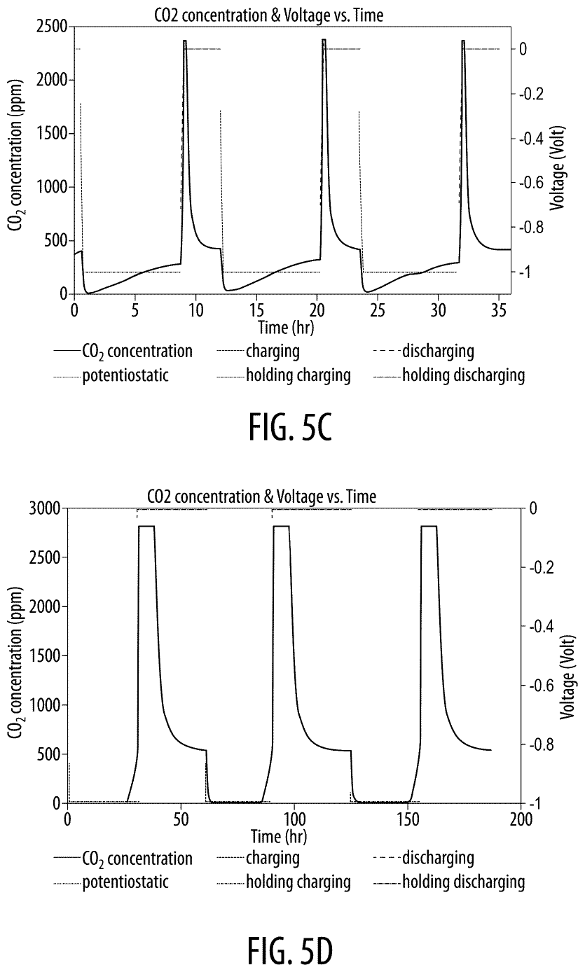

Referring to FIG. 5, carbon capture module 18 contained two mirror-polished titanium grade 7 plates (Tricor Metals., 3 and 8) with 13 cm×13 cm×1 cm size served as mechanical support and current collector for carbon capture module 18. The gas flowed in a radial pattern from the gas inlet port 1 in the center through the carbon cloth to the gas outlet port 2 in the periphery of the upper plate. Both gas ports were of 1 mm diameter and were connected to a ⅛ inch diameter stainless steel tubing via Swagelok connectors. Thirteen set screws held the entire module together through thirteen holes on the edge of each plate.

One electrode was soaked in 1 M NaCl, 1M MgCl₂ or 3M MgBr₂ for 2 hours, and used as positive electrode (e.g., electrode 7 of FIG. 3B). The other one was not soaked in the electrolyte and used as negative electrode (e.g., electrode 5 of FIG. 3B). A filter paper (Whatman Grade 2, GE Healthcare Life Sciences) with 8 cm×8 cm size was wetted by a 1 M NaCl solution and used as a separator between the two electrodes (separator 6 of FIG. 3B). A 9 cm×9 cm EPDM rubber sheet ( 1/16″, McMaster-Carr, gasket 9 of FIG. 3B) with an 8 cm×8 cm opening was placed between the upper and bottom plates and served as gasket. The sandwich made of the two electrodes and the separator was placed in the opening area of the gasket with the positive electrode being in contact with the bottom plate. A 7.5 cm×7.5 cm sized carbon cloth (AvCarb 1071 HCB, gas permeable layer 4 of FIG. 3B) was placed between the negative electrode and upper plate, and acted as gas diffusion layer. The upper and bottom plates were then clamped together by electrically insulated set screws. These screws were tightened evenly to 20 in·lb using a torque wrench.

The energetic performance of the carbon capture module was evaluated using four metrics, namely the specific capacitance (C, F·g⁻¹), the Coulombic efficiency (η_{c}, %), the energy efficiency (ηₑ, %), and the energy loss (ΔE, J).

The specific capacitance was calculated from the galvanostatic charge curve using the following equation:

$$C = \frac{4 \cdot I \cdot {t}_{g}}{m \cdot Δ U} ,$$

where I(A) is the constant current, t_{g}(s) is the galvanostatic charge duration, m (g) is the total mass of activated carbon in the two electrodes, and ΔU (V) is the change in cell voltage. Note that only the galvanostatic charge steps contribute to the specific capacitance.

The Coulombic efficiency is calculated by

$${η}_{c} = \frac{{Q}_{d}}{{Q}_{c}} \times 100 \% ,$$

where Q_{c} (C) and Q_{d} (C) are the total charge flowed into or out of the carbon capture module during charge and discharge process (galvanostatic charge/discharge step plus the following holding step if any), respectively.

The energy efficiency is calculated by

$${η}_{e} = \frac{{E}_{d}}{{E}_{c}} \times 100 \% ,$$

where E_{c} (J) and E_{d} (J) are the total energy consumed or delivered by the carbon capture module during the charge and discharge process (galvanostatic charge/discharge step plus the following holding step if any), respectively.

The energy loss is calculated as

$$Δ E = {E}_{c} - {E}_{d} ,$$

Five metrics were used to evaluate the carbon capture module adsorption performance. They are the adsorption capacity (AC, mol·kg⁻¹), the electron efficiency (EE, molecules electron⁻¹), the energy consumption (EC, KJ·mol⁻¹), the adsorption rate (AR, mol·kg⁻¹·s⁻¹), and the time-energy efficiency (TEE, mol·kJ⁻¹·s⁻¹).

The adsorption capacity indicates the CO₂ amount adsorbed per unit mass of carbon material, and is calculated as

$$A C = \frac{{n}_{a , {CO}_{2}}}{{m}_{n . e}} ,$$

where m_{n,e} (kg) is the weight of activated carbon in the negative electrode, and n_{a,CO2} (mol) is the amount of adsorbed CO₂. The carbon capture modules have a high selectivity for CO₂ over N₂. Therefore, n_{a,CO2} can be calculated according to

$${n}_{a , CO 2} = \frac{P}{R T} ( {\int }_{0}^{t} {f}_{i} d t - {\int }_{0}^{t} {f}_{e} d t ) ,$$

where t(s) refers to the time of the total charge process, including the galvanostatic charge step and the following holding step if any; T (296 K) is the temperature, and R (8.314 J·mol⁻¹·K⁻¹) is the ideal gas constant; fᵢ and fₑ (L·s⁻¹) are the flow rate of gaseous influent (1.7×10⁻⁵ L·s⁻¹) and effluent gas, respectively. The gaseous effluent flow rate is calculated as

$${f}_{e} = \frac{100 - {C}_{i}}{100 - {C}_{e}} {f}_{i} ,$$

where Cᵢ and Cₑ (%) are CO₂ concentration in gaseous influent (e.g., 15% or 400 ppm) and effluent gas, respectively. Cₑ was measured and recorded by the CO₂ analyzer.

The charge efficiency denotes the number of adsorbed CO₂ molecules per electron stored in the electrodes, and is calculated as

$$E E = \frac{{n}_{a , {CO}_{2}}}{{n}_{c . e}} = \frac{{n}_{a , {CO}_{2}}}{{Q}_{c}} \times F ,$$

where n_{c,e} (mol) is the number of capacitively stored electrons, Q_{c} (C) is the capacitively stored charge, and F (96485 C·mol⁻¹) is Faraday constant.

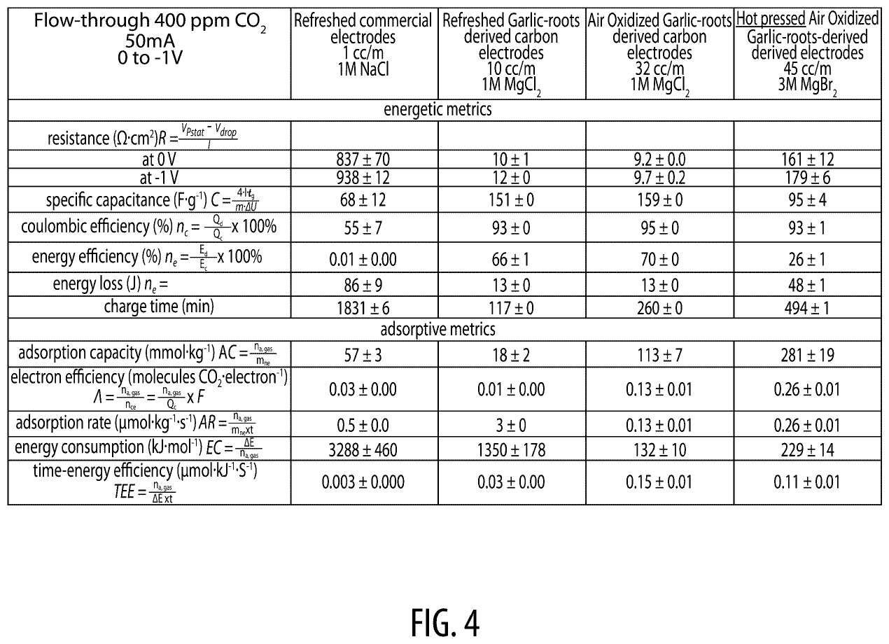

FIG. 4 provides a table showing the energetic and adsorptive performance from experiments with different electrodes in a summarized form. The most favorable performance was obtained for garlic-roots derived carbon that have been prepared from garlic roots with potassium carbonate as an activator at a temperature of 800° C. (mass ratio garlic roots:K₂CO₃=1:4) and were post-treated in air at 300° C. They showed the lowest energy consumption (132 KJ/mol) at a high CO₂ adsorption capacity (113 mmol·kg⁻¹). When the electrodes were hot-pressed at even higher adsorption capacity was even higher (281 mmol/kg), but the energy consumption was somewhat higher (229 KJ/mol). The performance of the commercially obtained electrodes were inferior in terms of both sorption capacity and energy consumption. Also, the garlic electrodes that were post-treated with oxygen showed superior adsorptive and energetic performance.

Remarkably though, all four electrodes were able to fully remove the CO₂ from the gas stream, as visible from the graphs shown below. Upon charging, the CO₂ concentration drops from 400 ppm to 0 ppm, and only increases at the end of the adsorption cycle back to the original value (400 ppm). One can also see a sharp increase in CO₂ concentration upon discharge, indicating fast desorption. Upon full desorption, the CO₂ concentration returns to the original value of 400 ppm. One can also see that the adsorption-desorption cycles are repeatable over multiple cycles, and that there is no performance decline as the cycle number increases. This means that the carbon capture system is extremely selective for CO₂, and that it can remove even traces of CO₂ from gas mixtures. It also means that the electrodes likely have a long lifetime.

The carbon dioxide concentration as function of voltage for the four evaluated electrodes are shown in FIGS. 5A-5D. FIG. 5A is graph showing the change in carbon dioxide concentration as function of voltage for non-oxidized garlic root-derived carbon. FIG. 5B is graph showing the change in carbon dioxide concentration as function of voltage for air-oxidized garlic root derived carbon. FIG. 5C is graph showing the change in carbon dioxide concentration as function of voltage for hot-pressed, air-oxidized garlic root-derived carbon. FIG. 5D is graph showing the change in carbon dioxide concentration as function of voltage for commercial electrodes.

### Example 2

Non-limiting, exemplary capacitive carbon capture modules having 2, 4, 8 and 12 carbon capture cells in accordance with aspects of the invention were evaluated. To prepare the electrodes, the electrodes were prepared from 80 wt. % BPL 4×6 carbon (Calgon™), 5 wt. % conductive carbon black (VXCMAX22, Cabot Corporation™), 10 wt. % gluten (Hodgson Mill, food grade) and 5 wt. % polytetrafluoroethylene (PTFE, 60% dispersion in H₂O, Sigma-Aldrich™). The electrodes had dimensions of 7 cm×7 cm×0.7 mm.

The capacitive carbon capture modules where prepared to have bipolar electrode stacks. Specifically, two mirror-polished titanium grade 7 plates having a dimension of 13 cm×13 cm×1 cm served as current collectors for the module. Positive BPL carbon electrodes were soaked in the 1M NaCl electrolyte solution for 2 hours (“h”). Negative electrodes were not soaked in the electrolyte. In the carbon capture modules having a bipolar electrode stack, the electrodes were separated by cellulose-based filter papers having a size of 8 cm×8 cm size soaked with 1M NaCl solution. Interruption of the ionic current between the two ends of a bipolar electrode was achieved by inserting a titanium sheet (TA2 99% Purity, 8 cm×8 cm×0.1 mm), which is impenetrable for the electrolyte. Stacks of 9 cm×9 cm EPDM rubber sheets ( 1/16″, McMaster-Carr) with an 8 cm×8 cm opening were placed between the upper and bottom titanium plates to seal the cell. In order to check the potential distribution within the multi-pair electrode stacks, a titanium strip (0.8 cm×4.5 cm×0.1 mm) was inserted between the bottom side of the bipolar electrode and the separator. A 7.5 cm×7.5 cm sized carbon cloth was placed between the negative electrode and the upper plate or the titanium sheet and acted as gas diffusion layer. The upper and bottom plates were then clamped together by 16 electrically insulated set screws. These screws were tightened evenly to 20 in·lb using a torque wrench. The gas was distributed via the radial gas flow system, in which the gas flows from the inlet port in the center to the outlet port in the periphery of the capacitive carbon capture module. To obtain a uniform gas flow through the capacitive carbon capture modules, all layered components between the end plates had a circular opening with a diameter of 9 mm. A PTFE tubing ( 1/32 inch inner diameter (“ID”)× 1/16 inch outer diameter (“OD”)) with side openings ( 1/20″ in diameter) was inserted into the channel created by these openings in order to maximize even gas distribution within the capacitive carbon capture modules.

To prepare the electrolyte solution: NaCl was ACS grade reagents (99+% purity). Laboratory grade water (>18 MΩ·cm) was used for the preparation of 1M NaCl electrolyte solutions.

The voltage distribution between the electrode pairs was checked by connecting a multimeter (AstroAI, DM6000AR) to the titanium strips and plates. Cyclic voltammetry (CV), galvanic charge-discharge (GCD) and electrochemical impedance spectroscopy (EIS) were performed using a Gamry reference 3000 potentiostat. Gas separation experiments were carried out in continuous flow mode with the gas mixture flowing continuously through the module. The adsorption and desorption of carbon dioxide was detected by a Quantek carbon dioxide analyzer measuring the carbon dioxide concentration changes during the charge-discharge process. Before the start of the charge-discharge cycles, the carbon capture module was flushed with the 15% CO₂/85% N₂ gas mixture for a several hours to ensure conventional sorption of carbon dioxide to the electrodes and electrolyte was complete. The capacitive carbon capture module was charged and discharged using the “GCD+Pstat” method, comprising galvanostatic charge and discharge (GCD) at a constant current of 50 mA between 0 and 1V with 10 min potentiostatic (Pstat) holding steps at 0 V (after discharge) and 1V (after charge). Gas flow rates were adjusted with the electrode pair number in the stacks to obtain the full adsorption of CO₂ within same time range, and were 6 cc/min for 2 pairs, 16 cc/min for 4 pairs, 24 cc/m for 8 pairs and 36 cc/m for 12 pairs. Adsorptive and energetic performance metrics were calculated.

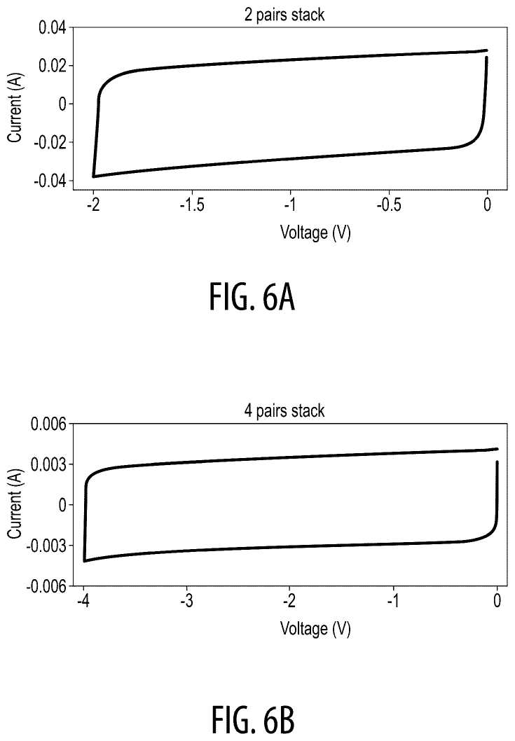

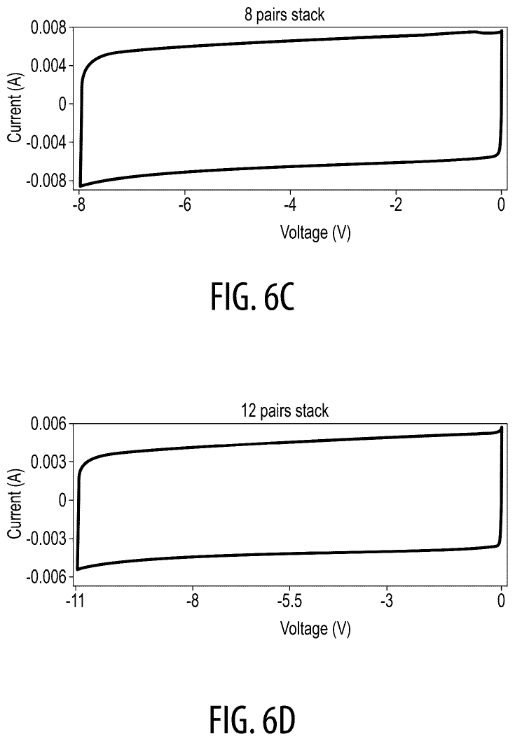

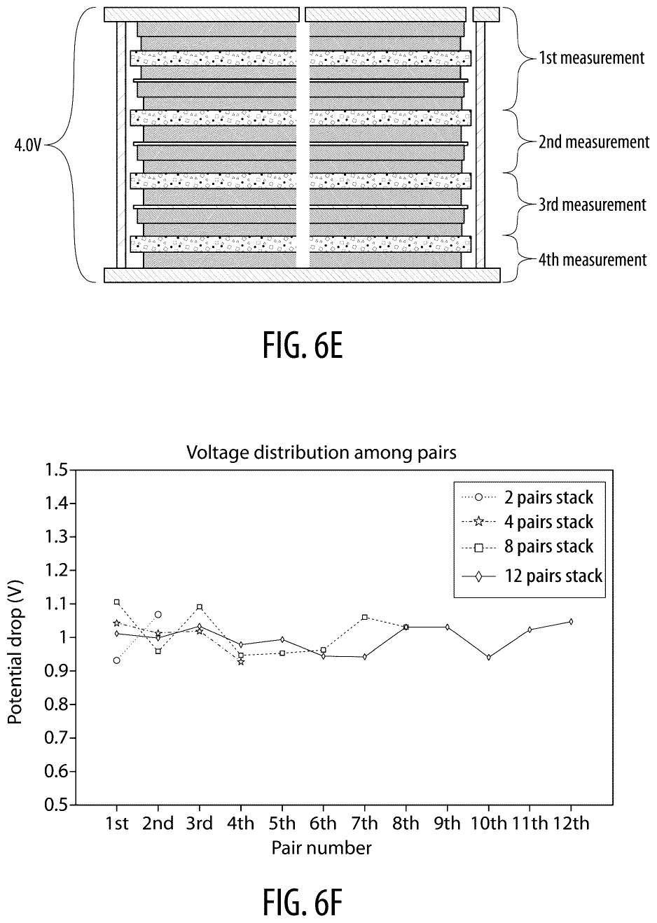

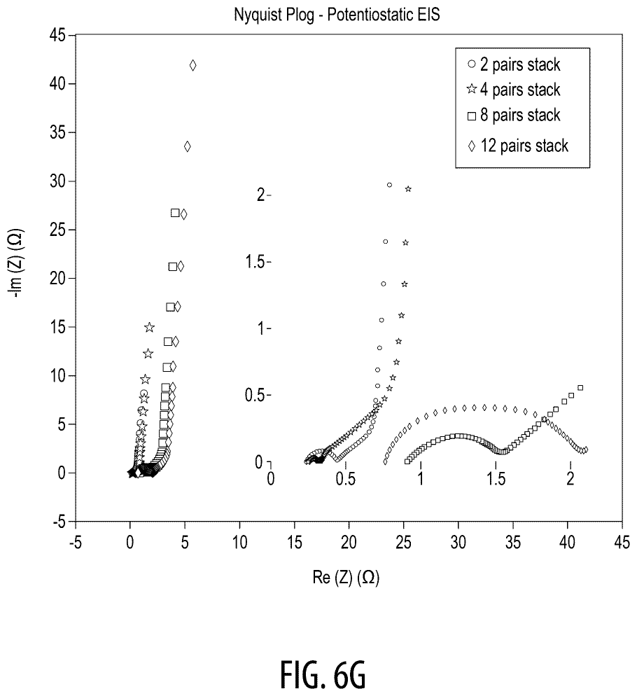

Prior to the gas separation experiments, the capacitive carbon capture modules were characterized by cyclovoltammetry in order to verify their expected capacitive behavior. The cyclic voltammograms of the capacitive carbon capture modules having 2, 4, 8 and 12 electrode pairs at the scan rate of 1 mV/s all show a highly rectangular shape indicative for near ideal capacitive charge storage behavior (see FIGS. 6A-6D).

The stack capacitance was calculated from CV curves using

$${C}_{stack} = \frac{Δ Q}{Δ V} = \frac{{\int }_{0}^{2 {V}_{0} / v} \vert i \vert dt}{2 {V}_{0}} ,$$

where Cstack (F) is the capacitance of the stack, ΔQ (C) are the accumulated charges, ΔV (V) is the total voltage change, V0 (V) is the voltage window, v (V/s) is the scan rate, i (A) is the resulting current, and t(s) is the time for a complete voltage scan.

The capacitance of a single cell was calculated using the following equation:

$${C}_{p a i r} = n \cdot {C}_{stack} ,$$

where Cpair (F) is the capacitance of a single cell with a pair of electrodes, and n is the number of cells (electrode pairs) in the stack.

The stack, cell, and specific capacitance of each tested stack are calculated and listed in Table 1.

TABLE 1

| | | | Stack | Electrode pair | Specific |
|---|---|---|---|---|---|
| Tested | | Voltage | Capacitance | Capacitance | Capacitance |
| stack | | window | (F) | (F) | (F/g) |
| 2 | pairs | 0 V to −2 V | 24.3 | 48.6 | 67.7 |
| 4 | pairs | 0 V to −4 V | 11.8 | 47.2 | 70.8 |
| 8 | pairs | 0 V to −8 V | 5.9 | 47.2 | 74.2 |
| 12 | pairs | 0 V to −11 V | 4.1 | 49.2 | 72.4 |

The stack capacitance decreased with the number of electrode pairs n in the stack according to

$$\frac{1}{{C}_{s t a c k}} = {\sum }_{1}^{n} \frac{1}{{C}_{n}} .$$

The specific capacitance for an electrode within the stack of carbon capture cells varies insignificantly from 67.7 to 74.2 F·g⁻¹. The minor deviations may be explained by minor differences between the electrodes as a result of small experimental errors during electrode preparation. The capacitance for each electrode pair in these stacks was also very similar, suggesting the equal capacitive contribution from each pair of electrodes.

This is further corroborated by the uniform voltage distribution among the electrode pairs in the stacks. The voltage distribution among pairs in stacks was checked by connecting a multimeter (AstroAI, DM6000AR) to the titanium strips or plates. An exemplary schematic of how to check the voltage distribution across the pairs of electrodes is shown in FIG. 6E with respect to a carbon capture module having four carbon capture cells. When applying voltages of 2, 4, 8 and 12 V to stacks with 2, 4, 8 and 12 electrode pairs, respectively, the potential drops across each electrode pair varied only slightly within the range of 0.9 V to 1.1 V for all stacks, signifying an almost equal behavior (e.g., see FIG. 6F).

The stacks were further analyzed by EIS at 0 V between 1 mHz and 100 kHz, and FIG. 6G presents the typical Nyquist Plot results. Calculated capacitance and resistance results from EIS tests are all tabulated in Table 2.

TABLE 2

| | | Stack | Specific | | | | |
|---|---|---|---|---|---|---|---|
| Tested | | Capacitance | Capacitance | ESR | Rₛₒₗ | R_{ct} | R_{diff} |
| stack | | (F) | (F/g) | (Ω) | (Ω) | (Ω) | (Ω) |
| 2 | pairs | 22 | 61 | 0.40 | 0.24 | 0.20 | 0.19 |
| 4 | pairs | 12 | 70 | 0.55 | 0.25 | 0.12 | 0.46 |
| 8 | pairs | 6 | 74 | 1.28 | 0.91 | 0.62 | 1.23 |
| 12 | pairs | 4 | 72 | 1.70 | 0.76 | 1.31 | 1.19 |

The equivalent series resistance (ESR) increased from 0.40, 0.55, 1.28 to 1.70Ω with increasing number of electrode pairs (2, 4, 8 and 12) in the stack. The increase is expected because the electrode pairs are connected in series. At low frequencies, the plots show slightly tilted, near vertical straight lines documenting the capacitive behavior of stacks. The stack capacitance was calculated from the EIS plot using the following equation:

$${C}_{stack} = - \frac{1}{2 π fIm ( Z )}$$

where f is the frequency and Im (Z) is the imaginary impedance.

The stack capacitances of all tested stacks derived from CV and EIS are in good agreement with each other. At intermediate frequencies, Warburg diffusion resistances (R_{diff}) are observed for the stacks having values of 0.19, 0.46, 1.23 and 1.29Ω, respectively. In the high frequency region, the stacks exhibit small semi-circles. The charge-transfer resistance R_{ct} calculated from the semicircles varies from 0.20 to 1.31Ω, indicating the presence of some pseudocapacitive charge-transfer processes on the electrode surface. Contact resistance between interfaces within the stacks may also make a contribution to R_{ct}. The solution, charge transfer and diffusion resistance tend to increase with the number of electrode pairs in the stack, with minor deviations. Rₛₒₗ and R_{diff} are somewhat larger than expected for the 8-cell stack, and R_{ct} is somewhat smaller than expected for the 4-cell stack, for reasons not being clear. Overall, the EIS analysis confirms the expected, capacitive behavior of the stack.

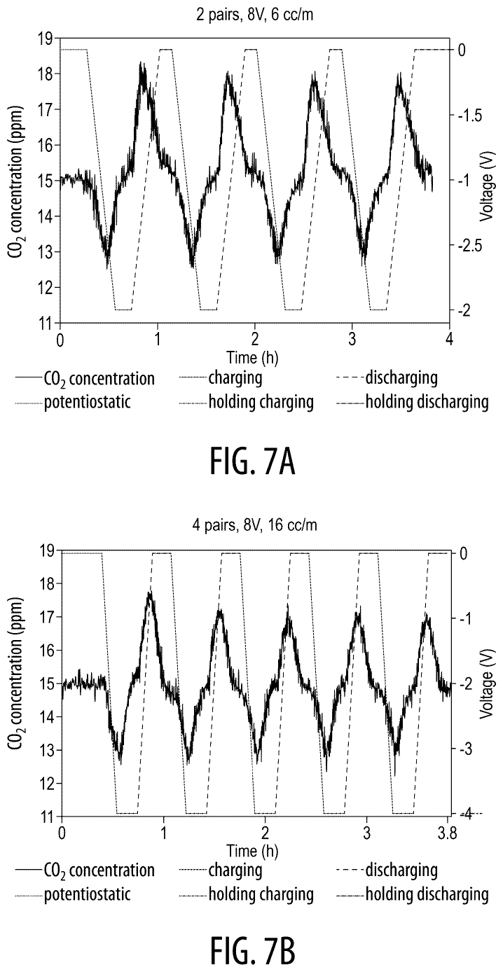

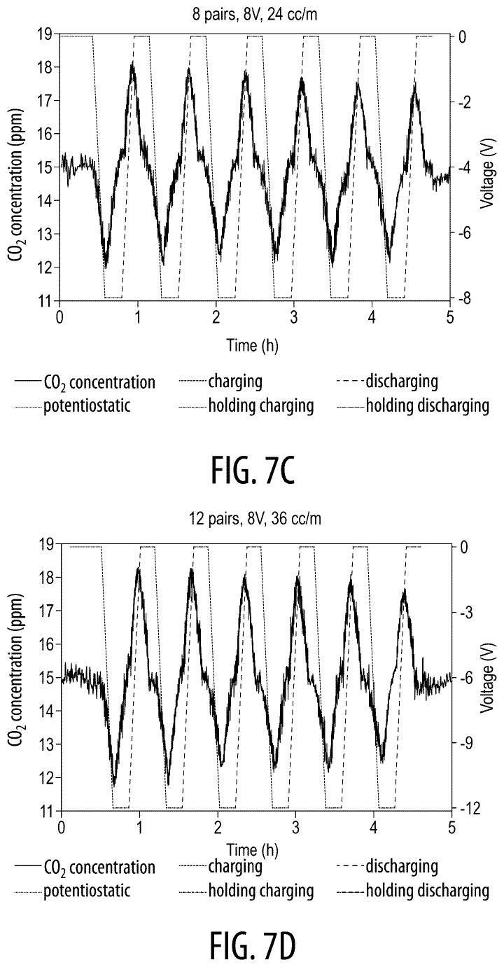

To determine the performance of capacitive carbon capture modules, the capacitive carbon capture modules were charged and discharged at a constant current of 50 mA to the final voltage (2V, 4V, 8V, and 12V, respectively). A 10-minute potential holding step was added after 1V, and OV were reached, respectively. The holding steps were added to allow the adsorption and desorption to complete. Concurrently, a continuous stream of 15 vol. % CO₂/85 vol. % N₂ was flown through the capacitive carbon capture modules. FIGS. 7A-7D shows the CO₂ concentration changes of the effluent gas, and the GCD voltage profiles as a function of time. Reversible adsorption was observed during the charging, and the subsequent potential holding step.

Desorption of carbon dioxide took place during the discharge process, and the subsequent potential holding step at OV. For each cycle, the carbon dioxide concentration first decreased to 12-13% during charging, and then returned to the original value (~15%) at the end of the 10 min holding step after charging. Upon discharge, the carbon dioxide concentration increased to 17-18% due to desorption, and then returned to 15%. Table 3 provides a summary of the energetic and adsorptive performance of the evaluated capacitive carbon capture modules having bipolar electrodes disclosed herein.

TABLE 3

| | 2 pairs stack | 4 pairs stack | 8 pairs stack | 12 pairs stack |
|---|---|---|---|---|
| | 6 cc/m | 16 cc/m | 24 cc/m | 36 cc/m |
| Parameter | 0 to −2 V | 0 to −4 V | 0 to −8 V | 0 to −12 V |
| Energetic metrics | | | | |
| R (Ω · cm²) at 0 V | 35.4 ± 0.2 | 57.4 ± 3.7 | 140.4 ± 7.9 | 145.0 ± 2.7 |
| R (Ω · cm²) at charged V | 37.1 ± 0.2 | 60.1 ± 0.4 | 110.4 ± 1.3 | 152.4 ± 0.6 |
| Rₚₐᵢᵣ (Ω · cm²) at 0 V | 17.7 ± 0.1 | 14.4 ± 0.9 | 17.5 ± 3.5 | 12.1 ± 0.2 |
| Rₚₐᵢᵣ (Ω · cm²) at charged V | 18.6 ± 0.1 | 15.0 ± 0.1 | 13.8 ± 0.0 | 12.7 ± 0.5 |
| C [symbol] (F · g [symbol] ) | 75.3 ± 1.2 | 77.2 ± 0.1 | 77.7 ± 1.7 | 76.9 ± 0.0 |
| η [symbol] (%) | 94.9 ± 0.5 | 98.4 ± 1.0 | 96.1 ± 2.4 | 98.6 ± 0.2 |
| η [symbol] (%) | 67.3 ± 1.5 | 77.7 ± 0.2 | 80.5 ± 2.7 | 84.4 ± 0.2 |
| ΔE (J) | 21.4 ± 1.4 | 22.7 ± 0.3 | 44.2 ± 7.8 | 47.4 ± 0.7 |
| Q [symbol] (C) | 56.1 ± 0.6 | 44.5 ± 0.4 | 50.8 ± 1.3 | 47.0 ± 0.1 |
| t [symbol] (min) | 26.9 ± 0.0 | 24.2 ± 0.0 | 26.1 ± 0.3 | 25.1 ± 0.0 |
| Adsorptive metrics | | | | |
| n [symbol] (μmol) | 151.1 ± 5.4 | 276.8 ± 6.8 | 562.1 ± 10.6 | 787.3 ± 12.2 |
| AC (mmol · kg⁻¹) | 61.3 ± 2.2 | 55.2 ± 1.4 | 58.5 ± 1.1 | 55.3 ± 0.9 |
| A (molecules CO₂ · electron⁻¹) | 0.13 ± 0.00 | 0.15 ± 0.00 | 0.13 ± 0.01 | 0.14 ± 0.00 |
| AR (μmol · kg [symbol] · s [symbol] ) | 38.0 ± 1.4 | 38.1 ± 0.9 | 37.4 ± 1.1 | 36.8 ± 0.6 |
| P (mmol · h⁻¹ · m [symbol] ) | 69.8 ± 2.5 | 142.2 ± 3.4 | 267.3 ± 7.9 | 389.8 ± 6.0 |
| EC (kJ · mol⁻¹) | 142.2 ± 15.3 | 81.9 ± 0.9 | 78.7 ± 15.4 | 60.2 ± 0.5 |

[symbol]

indicates data missing or illegible when filed

The adsorptive and energetic performance metrics of the capacitive carbon capture modules, which were derived from the concentration profiles and the charge-discharge curves are summarized in Table 1. These are the average resistance of an electrode pair in the stack Rpair (Ω·cm²), and the number of charges Qc,pair (C) per electrode pair.

$${R}_{p a i r} = \frac{R}{n} ,$$

$${Q}_{c , p a i r} = \frac{Q c}{n}$$

The specific capacitance calculated from the GCD curves for the evaluated stacks are very similar, having values of 75, 77, 78 and 77 F·g-1, and are consistent with the results derived from CV and EIS tests. In a carbon capture module using bipolar electrodes as disclosed herein, the charging time should be independent from the number of carbon capture cells in the stack. The measured charging time for all tested stacks was indeed nearly constant, and minimally fluctuated between 24 to 27 min. The coulombic efficiency for all stacks was very high, varying insignificantly from 95% to 99%. The high coulombic efficiency validates the uniformity of the electrode pairs assembled in the stack of carbon capture cells. The charges stored in each electrode pair for the different stacks are also very similar (~50 C). The absolute, adsorbed amount of carbon dioxide in the modules, and the productivity increased proportionally with the increasing number of electrode pairs (151 to 787 μmol, and 70 to 390 mmol·h⁻¹·m⁻²), respectively. The adsorption capacities of these stacks remained constant within experimental error margins (~58 mmol kg⁻¹), indicating that each electrode pair adsorbs about the same amount of carbon dioxide, regardless of the scale of the module. Likewise, the adsorption rates (~38 μmol kg⁻¹·s⁻¹) also remain about constant. The electron efficiency stays at a constant value of ~0.14 molecules CO₂·electron⁻¹ for all tested stacks, confirming that all electrode pairs behave uniformly, regardless of number of cells in the stack. Overall, the results show that the carbon capture modules disclosed herein are scalable without loss of adsorptive performance.

The resistance in the stack of carbon capture cells was calculated from the IR drop at the GCD curves. Increasing the number of pairs in the stack of carbon capture cells increases the overall resistance (from 35 to 152 Ω·cm²) and the energy loss (from 21 to 47 J) in the carbon capture modules, which is consistent with the trends observed in EIS. The resistance per electrode pair at 1V decreased from 19 to 13 Ω·cm² with increasing cell number, which also leads to an increased round-trip energy efficiency from 67% to 84%, and an improved energy consumption from 142 to 60 kJ·mol⁻¹. This phenomenon can be explained by the different current flow pattern within a bipolar electrode compared to a (monopolar) end electrode. In a carbon capture module with a single carbon capture cell, current flows in-plane within the current collector plate, and then into the electrode. In a bipolar electrode, the current flows directly through-plane from one electrode end through the Ti foil to the other end of the bipolar electrode. The resistance is lower in the bipolar electrode because the resistor length is shorter, and the resistor area is larger. With increasing number of electrode pairs, the fraction of the bipolar electrode pairs in the stack of carbon capture cells increases from 1:2 (50%) to 11:12 (91.7%) leading to lower energy consumption. This suggests that a further increase in the number of bipolar electrodes should lead to even lower energy consumption. Overall, scaling carbon capture modules via the introduction of bipolar electrodes appeals as an effective strategy to minimize the energy consumption in carbon capture module.

Based on this example, it was determined that the maximum voltage can be increased proportionally with the number of electrode pairs in the stack to 2, 4, 8, and 12 V, respectively without loss of capacitive behavior. The sorption capacity (~58 mmol·kg-1) and the adsorption rates (~38 μmol·kg-1·s-1) remain constant for all stacks demonstrating scalability. Also, the coulombic efficiency (~97%), specific capacitance (~77 F·g-1) and electron efficiency (~0.14 molecules CO₂·electron-1) are similar for all investigated stacks.

The productivity scales with the number of electrode pairs. The scaling strategy significantly decreases the resistance and energy loss per cell, which substantially increases energy efficiency and reduces energy consumption. For a 12-cell stack, the energy consumption is reduced to 60 kJ·mol⁻¹ compared to 142 kJ·mol⁻¹ for a 2-cell stack, and 202 kJ·mol⁻¹ for a single cell. Further improvements could be made by the replacement of the relatively expensive titanium foil, by cheaper alternatives, for example carbon black-infused polyethylene films which recently proved effective in aqueous ZnBr₂ battery stacks with bipolar electrodes. In addition, gas flow channels could be imprinted into the electrodes, eliminating the need of the relatively expensive carbon cloth a gas conduit. Sorption capacity could be increased by the replacement of BPL carbon with garlic-root derived carbon and NaCl by MgBr₂ electrolytes, which performed significantly better in previous single cell experiments.

### Example 3

Two carbon capture modules 801, 802 can be coupled to produce a carbon capture system that operates in continuous flow mode (FIGS. 8A-8B). FIGS. 8A and 8B illustrate an exemplary flow scheme of a gas separation system operating on the basis of supercapacitance. As a brief overview, FIG. 8A depicts a first state wherein carbon capture module 801 is in a charged state and carbon capture module 802 is in an uncharged state and FIG. 8B depicts a second state wherein carbon capture module 801 is in an uncharged state and carbon capture module 802 is in a charged state. More specifically, in an exemplary system such as that illustrated in FIGS. 8A-8B, in a first state, a gas mixture (in this non-limiting example, CO₂/N₂) is directed to and only has access to a first carbon capture module 801. In this first state (FIG. 8A) the first carbon capture module 801 is in adsorption mode (charged) and a second carbon capture module 802 is in desorption mode (discharged). While charged, the electrode selectively adsorbs CO₂, allowing N₂ to pass through. When this apparatus 801 has absorbed CO₂ to the maximum possible capacity for the electrode, the gas access is closed.

The carbon capture system can then be switched to a second state (FIG. 8B) wherein the gas access to carbon capture module 801 is closed, carbon capture module 801 is discharge, gas access is redirected to carbon capture module 802 and carbon capture module 802 is charged. The first carbon capture module 801 is discharged, thereby desorbing the CO₂. This releases the CO₂ from the first carbon capture module 801, which can stream out of the system and optionally collected. Meanwhile, gas can stream through carbon capture module 802, whereby CO₂ is selectively adsorbed and N₂ is allowed to pass through until it is saturated with CO₂. Gas access to carbon capture module 802 is then closed, carbon capture module 802 is discharged, and CO₂ is desorbed from the second carbon capture module 802. Gas access is then passed back to carbon capture module 801, reverting the carbon capture system back to the first state. This process can continue indefinitely such that one of the carbon capture modules is being fed a mixed gas stream and is charged and adsorbing a gas from the mixture while the other carbon capture module is discharged and is desorbing and streaming the previously adsorbed gas out of the carbon capture module. In certain embodiments, energy can be conserved by shuttling the charge between the carbon capture modules 801 and 802. In some exemplary embodiments, the carbon capture system can optionally further comprise one or more flow meters 804 and optionally a mass flow controller 805. The gas access to the carbon capture module can be switched by a three-way valve 803. The amount of separated gas per time and sorbent mass can be measured using two mass flow meters 804 and, optionally, a mass flow controller 805.

### Example 4

Electrodes were prepared for use in carbon capture modules and capacitive carbon capture systems, such as those disclosed herein. The electrodes were fabricated using the following procedure: 0.083 g 60% Polytetrafluoroethylene (PTFE) dispersion (Sigma-Aldrich) was dispersed in 10 mL ethanol and stirred. PTFE/gluten mixtures were used as the binder. After the PTFE was completely dissolved, 0.8 g BPL carbon, 0.1 g gluten (Hodgson Mill, food grade), and 0.05 g conductive carbon black (Cabot Corporation) was added to the solution. PTFE was chosen because of its excellent film-forming abilities. The gluten served as a co-binder which ensured sufficient hydrophilicity of the binder mixture. Carbon black was added to increase the conductivity of the electrodes. The final ratio of BPL:Carbon black:Gluten: PTFE was 80:5:10:5 by mass. The solution was then stirred at a temperature of 60° C. in a vial for 2 hours. Afterwards, the ethanol was evaporated at a temperature of 80° C. until the mixture became a slurry. The slurry was then transferred to a flat glass panel and mixed thoroughly with a metal spatula for 1 hour until the slurry became a sticky dough-like substance. Then, the dough was rolled against a glass slide using a glass vial having a diameter of 2.54 cm to form a sheet with uniform thickness. Subsequently, two 1.4 cm×1.4 cm sheets were cut out and used as electrodes. The mass of the electrodes was adjusted by modifying the thickness of the sheet. The electrodes were dried at a temperature of 100° C. for 12 hours in a vacuum oven to remove any solvent residue (the pressure in the oven was ~25 mmHg). Assembly of the Module: Two square aluminum plates with 3 cm×3 cm size served as mechanical support and current collector for the device. The thickness for the top and bottom aluminum plates were ½ inch and ¼ inch, respectively. Two holes (1 mm diameter), which served as gas inlet and outlet ports, were drilled into the top aluminum plate. These holes were connected to ⅛ inch diameter stainless steel tubing via Swagelok connectors. In addition, each aluminum plate had eight additional holes near the edges which would fit eight set screws that would hold the entire module together. Both aluminum plates had a 2 cm×2 cm×1 mm recess area in the center. Two square (2×2 cm) graphite plates with a thickness of ¼ inch (grey) were fitted into the recess of the aluminum plates. The top graphite plate contained two holes (1 mm diameter) that aligned with the holes in the top aluminum plate. The top graphite plate had 1 mm wide and 1 mm deep serpentine gas flow channels, leading from the first hole in the graphite plate to the second hole in the graphite plate. Graphite was chosen as material because it does not corrode when in contact with aqueous electrolytes and provides good electronic conductivity.

One of the electrodes prepared as described above was soaked completely in 1 M NaCl for 2 hours, and used as the negative electrode. The other electrode was wetted with electrolyte solution on only one side, so that the other side remained accessible for gas molecules. A separator membrane (1.6 cm×1.6 cm) was cut from a WHATMAN® Grade 2 filter paper (GE Healthcare Life Sciences) and placed in between the electrodes to prevent short-circuiting between them. The sandwich made of the two electrodes and the separating membrane was transferred onto the bottom graphite plate, so that the fully electrolyte-soaked bottom electrode was in contact with this graphite plate. A 2 cm×2 cm rubber seal (gasket) with a 1.7 cm×1.7 cm opening was cut from an EPDM rubber sheet (⅛ in, MCMASTER-CARR®) and placed on top of the electrode sandwich. A high-vacuum grease (APIEZON® M grease) was applied to the rubber seal to prevent leaking. Then a 1.4 cm×1.4 cm sized carbon cloth (AVCARB® 1071 HCB) was placed on the top electrode. The cloth acted as gas permeable layer that would provide gas access to the entire electrode area. The top aluminum plate and bottom aluminum plate were then clamped together by 8 electrically insulating set screws. These screws were tightened evenly to 15 Nm using a torque wrench. A complete materials sheet for the device is shown in Table 4.

TABLE 4

| Component | Vendor | Size/Model No. |
|---|---|---|
| Pressure transducer | OMEGA ® | MMA015C1T3C2TA5S |
| Dielectric | SWAGELOK ® | SS-6-DE-6 |
| connection | | |
| Stainless Steel Tube | SWAGELOK ® | SS-T2-S-028-20, ⅛ in |
| Graphite plate | MCMASTER-CARR ® | ¼ in |
| Aluminum plate | MCMASTER-CARR ® | ½ in, ¼ in |
| Separator membrane | WHATMAN ® | Filter paper grade 2 |
| Rubber sealer | MCMASTER-CARR ® | High-Strength 60A |
| | | EPDM rubber, ⅛ in |
| High vacuum grease | APIEZON ® | |
| Carbon Cloth | AVCARB ® | 1071 HCB, 20 cm*20 cm |

1-56. (canceled)

57. A capacitive carbon capture system comprising:
one or more carbon capture modules comprising:
a first current collector having a surface;
a second current collector having a surface and spaced from the first current collector;
a first carbon capture cell and a second carbon capture cell, the first carbon capture cell and the second carbon capture cell each comprising:
a first electrode comprising a first surface and a second surface opposed the first surface,
a second electrode spaced from the first electrode, the second electrode comprising a first surface and a second surface opposed the first surface,
an electrolyte solution in contact with the second surface of the first electrode and the first surface of the second electrode, and
a gas permeable layer comprising a first surface and a second surface opposed to the first surface; and
a barrier extending between the first carbon capture cell and the second carbon capture cell, the barrier being electrically conductive and not permeable for ions.

58. The capacitive carbon capture system according to claim 57 further comprising: a separator extending between the first electrode and the second electrode of each of the first carbon capture cell and the second carbon capture cell, wherein the separator is a porous material and the electrolyte solution is disposed in the separator.

59. The capacitive carbon capture system according to claim 57, wherein the first carbon capture cell and the second carbon capture cell are positioned at least partially in the space between the first current collector and the second current collector.

60. The capacitive carbon capture system according to claim 57, wherein the barrier extends adjacent to the second surface of the second electrode of the first carbon capture cell and adjacent to the first surface of the gas permeable layer of the second carbon capture cell, wherein the barrier is configured to prevent movement of ions from the first carbon capture cell to the second carbon capture cell.

61. A capacitive carbon capture system comprising:
one or more carbon capture modules comprising:
a first current collector having a surface;
a second current collector having a surface and spaced from the first current collector;
a first carbon capture cell and a second carbon capture cell, wherein the first carbon capture cell and the second carbon capture cell are positioned at least partially in the space between the first current collector and the second current collector, the first carbon capture cell and the second carbon capture cell each comprising:
a first electrode comprising a first surface and a second surface opposed the first surface,
a second electrode spaced from the first electrode, the second electrode comprising a first surface and a second surface opposed the first surface,
an electrolyte solution in contact with the second surface of the first electrode and the first surface of the second electrode, and
a gas permeable layer comprising a first surface and a second surface opposed to the first surface, the second surface of the gas permeable layer extending adjacent to the first surface of the first electrode; and
a barrier extending between the first carbon capture cell and the second carbon capture cell, the barrier being electrically conductive and non-permeable for ions, wherein the barrier extends adjacent the second surface of the second electrode of the first carbon capture cell and adjacent the first surface of the gas permeable layer of the second carbon capture cell,
wherein the first surface of the gas permeable layer of the first carbon capture cell extends adjacent to the surface of the first current collector and the second surface of the second electrode of the second carbon capture cell extends adjacent to the surface of the second current collector.

62. The capacitive carbon capture system according to claim 61, wherein the carbon capture module further comprises a feed inlet conduit extending transversally through the first and the second surface of the gas permeable layer of the first carbon capture cell and extending transversally through the first and the second surface of the gas permeable layer of the second carbon capture cell, and
wherein the carbon capture module further comprises a feed outlet conduit extending transversally through the first and the second surface of the gas permeable layer of the first carbon capture cell and extending transversally through the first and the second surface of the gas permeable layer of the second carbon capture cell.

63. The capacitive carbon capture system according to claim 61 further comprising: a feed stream received by the gas inlet conduit, the feed stream comprising CO₂.

64. The capacitive carbon capture system according to claim 61, wherein one or both of the first electrode and the second electrode comprise a porous capacitive and/or pseudocapacitive material.

65. The capacitive carbon capture system according to claim 61, wherein one or both of the first electrode and the second electrode comprise a material selected from activated carbons, oxides, sulfides, nitrides, carbides, or a combination of two or more thereof.

66. The capacitive carbon capture system according to claim 61, wherein the electrolyte solution comprises a salt that is deliquescent, the salt being selected from MgBr₂, MgCl₂, CsF, CaCl₂, KF, CaBr₂, LiCl, LiBr, and a combination thereof.

67. The capacitive carbon capture system according to claim 61, wherein at least one carbon capture module is configured such that the first and second carbon capture cells are in electrical connection with only one current collector.

68. The capacitive carbon capture system according to claim 61, wherein the one or more carbon capture modules consists of two current collectors and wherein each of the capture modules consists of two current conductors.

69. The capacitive carbon capture system according to claim 61, wherein the first carbon capture module and the second carbon capture module are configured to be capacitively charged by applying a voltage to the respective carbon capture module, wherein the first carbon capture module and the second carbon capture module are configured to be alternately capacitively charged.

70. The capacitive carbon capture system according to claim 69, wherein capacitively charging the first carbon capture module and/or the second carbon capture module comprises absorbing CO₂ from the feed stream into the electrolyte solution of the respective carbon capture module, wherein the CO₂ absorbed in the electrolyte solution hydrolyzes to form a cation and an anion.

71. The capacitive carbon capture system according to claim 70, wherein capacitively charging the first carbon capture module and/or the second carbon capture module further comprises the cation or the anion being adsorbed to the first electrode.

72. The capacitive carbon capture system according to claim 70, wherein when voltage is applied to the first electrode and the second electrode of the respective carbon capture module, the cation is adsorbed to one of the first electrode or the second electrode and the anion is adsorbed to the other of the first electrode or the second electrode.

73. The capacitive carbon capture system according to one of claim 69, wherein the first carbon capture module and the second carbon capture module are configured to be capacitively discharged, and
wherein the electricity associated with discharging the first carbon capture module or the second carbon capture module is used for charging the other of the first carbon capture module or the second carbon capture module.

74. The capacitive carbon capture system according to claim 73, wherein capacitively discharging one of the first carbon capture module or the second carbon capture module releases gaseous CO₂.

75. The capacitive carbon capture system according to claim 61, wherein the one or more carbon capture modules comprise a bipolar electrode, the bipolar electrode is formed from the second electrode of the first carbon capture cell, the barrier, the first electrode of the second carbon capture cell and the gas permeable layer of one of the first carbon capture cell or the second carbon capture cell, and
wherein the one or more carbon capture modules comprise a number of bipolar electrode that is one less than the number of carbon capture cells in the respective carbon capture module.

76. A cyclic process using the capacitive carbon capture system according to claim 61, which comprises the following steps:
providing the feed stream to the first carbon capture module;
capacitively charging the first carbon capture module;
prohibiting flow of the feed stream to the first carbon capture module;
optionally, evacuating the first carbon capture module to reach a pressure of about 0.1 to about 0.3 atmosphere;
capacitively discharging the first carbon capture module;
releasing gas from the first module, and purging the desorbed gas out of the module
providing the feed stream to the second carbon capture module;
capacitively charging the second carbon capture module;
prohibiting flow of the feed stream to the second carbon capture module optionally, evacuating the second carbon capture module to reach a pressure between about 0.1 to about 0.3 atmospheres,
capacitively discharging the second carbon capture module; and
releasing gas from the second carbon capture module, and purging the desorbed gas out of the module.
